(19) United States
(12) Patent Application Publication
(10) Pub. No.: US 2024/0034039 A1
(43) Pub. Date: Feb. 1, 2024

(54) PAPER CUSHIONED SHIPPING ENVELOPES AND METHODS OF MAKING THE SAME

(71) Applicant: David Paul Goodrich, Sedona, AZ (US)

(72) Inventor: David Paul Goodrich, Sedona, AZ (US)

(21) Appl. No.: 18/232,316

(22) Filed: Aug. 9, 2023

Related U.S. Application Data
(63) Continuation-in-part of application No. 17/891,737, filed on Aug. 19, 2022.
Application No. 17/891,737 is a division of application No. 16/870,195, filed on May 8, 2020, now Pat. No. 11,440,305.
(60) Provisional application No. 62/845,293, filed on May 8, 2019.
(60) Provisional application No. 63/396,918, filed on Aug. 10, 2022.

(51) Int. Cl. B32B 29/00; B65D 81/03; B32B 3/12; B32B 3/26; B32B 3/04; B32B 3/28; B31F 1/07; B31D 5/00

(52) U.S. Cl. CPC B32B 29/005; B65D 81/03; B32B 3/12; B32B 3/266; B32B 3/04; B32B 3/28; B31F 1/07; B31D 5/0065; B31D 5/006; B65D 27/005

(57) ABSTRACT

According to some illustrative embodiments, a protective product is provided that includes: an envelope having a two-layer wall structure, the two-layer wall structure including a) a first outer paper layer, and b) a second inner paper layer, wherein the second inner paper layer includes width-wise positional variations of the side surface of the second inner sheet that cushions items placed within an inner pouch of the envelope, and forms an interior wall of the inner pouch of the envelope and directly contacts the items placed within the inner pouch of the envelope. In some preferred implementations, the width-wise positional variations of the side surface of the second inner paper layer includes pleats, undulations and/or embossments, and, preferably, the pleats, undulations and/or embossments include ridges that extend perpendicular or substantially perpendicular to an outlet of the envelope.

### CROSS REFERENCE TO RELATED APPLICATIONS

This application is a) a non-provisional of U.S. Provisional Application No. 63/396,918, filed Aug. 10, 2022 and b) a continuation-in-part of U.S. application Ser. No. 17/891,737, filed Aug. 19, 2022, which is a divisional of U.S. application Ser. No. 16/870,195, filed May 8, 2020, now U.S. Pat. No. 11,440,305, issued Sep. 13, 2022, which is a non-provisional of U.S. Provisional Application Ser. No. 62/845,293, filed May 8, 2019, the entire disclosures of which prior applications are all incorporated herein by reference in their entireties as part of the description of the present application.

### BACKGROUND

### Field

The preferred embodiments of the present invention relate to the manufacture and/or use of shipping envelopes or pouches employing paper for cushioning.

### Description of the Background Art

The background art for the manufacturing of a shipping envelope has been manufactured with plastic bubble, plastic bubble-paper combination, shredded newsprint, Kraft paper, and the like. The plastic materials are quite flexible and, in some cases, provide adequate initial cushioning whereas the Kraft paper is somewhat less flexible. Background art paper alternatives have been costlier to manufacture and also more costly for the end user to ship due to their increased weight as compared to plastics.

### Disclosure of U.S. Application Ser. No. 16/870,195

The following sub-sections, shown in italics, along with the accompanying FIGS. 1-22 contain the disclosure of parent application Ser. No. 16/870,195. In the following sub-sections in italics, references to the “preferred embodiments” and the “present invention” refer to the subject matter of parent application rather than the present application.

### BRIEF DESCRIPTION OF DRAWINGS (RELATED TO SER. NO. 16/870,195)

A number of preferred embodiments of the invention will be described with the accompanying drawings, in which:

FIG. 1 is a side view of the composite material of expanded slit sheets enveloped in indented Kraft sheets;

FIG. 2 is a perspective view of the composite material of expanded slit sheets enveloped in indented Kraft sheets;

FIG. 3 is a schematic side view of the manufacturing process;

FIG. 4 is a top view of the composite material;

FIG. 5 is a top view of the composite material with fold lines and double-sided adhesive;

FIG. 6 is a top view of the composite material folded into the unclosed envelope shape;

FIG. 7 is a perspective view of the composite unclosed envelope with release liner, where a pouch area is created by side gluing side crushing areas folding at a crush/fold area;

FIG. 8 is a perspective view of the composite closed envelope;

FIG. 9 is a perspective view showing a notched region for tear opening of a sealed envelope;

FIG. 10 is a side view of a single sided outer embossed layer of Kraft, a double layer of expanded paper and an inner layer of raised and recessed embossed paper;

FIGS. 11, 11A, 11B, 11C, and 11D are schematic representation of various patterns and sizes of hexagonal shaped embossments;

FIG. 12 is a side view of a single sided embossed layer, a layer of flat Kraft paper and a double layer of expanded paper between the embossed and flat layers;

FIG. 13 is a side view of an embossed sheet;

FIG. 14 is a side view of a two sided embossed paper as a cushioning inner layer;

FIG. 15 is a side view of the double sided embossed layer of FIG. 14 in combination with an inner and outer layer of single sided embossed Kraft paper;

FIG. 16 is a perspective view of the combination of FIG. 15;

FIG. 17 is a perspective view of a fan fold cushioning layer in combination with embossed layers;

FIG. 18 is a perspective view of an undulating two-sided pattern in combination with an embossed layer;

FIG. 19 is a plan view of two consecutive envelope pads that have been crushed in fold areas and die-cut in envelope end crush areas while, simultaneously being maintained under tension in the manufacturing direction in the side crushing areas;

FIG. 20 is a side view of the upper rotary tool that provides the crush and cut for making the padded envelope;

FIG. 21 is a side view of the die cut crush rotary system; and

FIG. 22 is a perspective view of the rotary padded envelope pad making section.

### DEFINITIONS RELATING TO THE PREFERRED EMBODIMENTS (RELATED TO SER. NO. 16/870,195)

In the preferred embodiments, the term “envelope” is a package having an opening within which one or more item(s) can be inserted for storage and/or shipping. In some preferred embodiments, the opening of an “envelope” is closeable and sealable after the item or items is inserted for storage and/or shipping, such as, e.g., shipping via shipping services.

In the preferred embodiments, the term “pouch” refers to an area within an envelope in which one or more item(s) for storage and/or shipment is placed. In some preferred embodiments, the filled envelope can be placed within a shipping container.

In some preferred embodiments, the term “in-the-box shipping” of envelopes refers to a context in which an envelope is shipped within a box or container (such as, e.g., within a corrugated box). For example, such box or container can be employed to ship a plurality of envelopes contained therein and/or one or more envelope along with any other number of items. In the context of in-the box shipping of an envelope, the materials of the envelope can be modified, such as, e.g., to employ lighter paper and/or to not employ a durable and/or anti-rip outer layer which may otherwise be required which shipping the envelope without the protection of a surrounding box during in-the box shipping.

In the preferred embodiments, the terms “outer layer” and “exterior layer” means, in regard to an envelope, an outermost layer of the envelope.

In the preferred embodiments, the terms “inner layer” and “interior layer” mean, in regard to an envelope, a layer of the envelope that forms an interior surface of the envelope. For example, an item placed within an envelope would typically be in contact with an interior surface of the envelope.

In the preferred embodiments, the term “mailing envelope” refers to an envelope designed for shipping by USPS, UPS, FedEx and/or the like without being contained within a box or container as in the case of in-the box shipping. In the preferred embodiments, a mailing envelope preferably has a durable outer layer to compensate for shipping by itself without external protection of a box or container (e.g., to avoid ripping or tearing).

In the preferred embodiments, the terminology “uniformly opening slit” means slits as disclosed and/or claimed in PCT/US2014/054615.

In the preferred embodiments, the terminology “randomly opening slit” means slits as disclosed and/or claimed in U.S. patent application publication 2017/0203866, published Jul. 20, 2017. In some examples of this latter '866 publication, at least some adjacent layers have differing angles of inclination of land areas, resisting contraction and/or nesting.

In the preferred embodiments, the terminology “expandable” as applied to paper sheets, means a paper having a slit pattern that enables expansion of the paper, such as, e.g., as disclosed in U.S. Pat. Nos. (a) U.S. Pat. No. 5,538,778, (b) U.S. Pat. No. 5,667,871, (c) U.S. Pat. No. 5,688,578, and (d) and in PCT Application No. PCT/US2014/054615, the entire disclosures of which patents and PCT application are all incorporated by reference herein as though recited in full. In the preferred embodiments, a slit pattern is configured to enable the paper to be expanded lengthwise, with a related decrease in width. In some embodiments, the slit pattern produces a paper that increases in length due to the slit pattern when processed in an expander, such as, e.g., an expander of the type described in any of the following U.S. and PCT applications (a) 2017/0203866, (b) 2018/022266, (c) 2018/0127197, and (d) PCT/US2014/054615, incorporated herein by reference in their entireties.

In the preferred embodiments, the term “slit sheet” means an expandable paper sheet having a slit pattern, such as, e.g., disclosed in U.S. application publications (a) 2017/0203866, (b) 2018/0222665, and (c) 2018/0127197 and in PCT application PCT/US2014/054615, incorporated herein by reference in their entireties.

In the preferred embodiments, the term “envelope pad” includes a pad that is incorporated in an envelope to protect one or more item contained within the envelope. In some preferred embodiments, an envelope refers to the intermediate manufacturing process where the envelope has been cut and crushed to enable the next step of folding and gluing into its final envelope form.

In the preferred embodiments, the term “padded envelope” refers to a final envelope product design that provides a cushioning flexible shipping package.

In the preferred embodiments, the term “mouth” refers to a portion of the envelope that allows one or more item(s) to be placed within the envelope. In some embodiments, the mouth is formed when an envelope pad is glued into the shape of a padded envelope to create a pouch.

In the preferred embodiments, the term “extensible” as applied to paper sheets, means a paper as set forth in co-pending U.S. patent application Ser. No. 16/018,702, entitled Extensible Paper and Its Use In the Production of Expanded Slit Packaging and Void Fill Products, the entire disclosure of which is incorporated herein by reference. In addition, the term “extensible” as applied to paper sheets also includes paper that is processed such that a paper sheet is able to stretched, including extensible papers as described in the following U.S. Patents, Patent publications, and pending applications: (a) U.S. Pat. No. 3,908,071, (b) U.S. patent application Ser. No. 14/901,977 (U.S. Pat. No. 9,945,077), (c) PCT Publication No. WO1984002936, (d) U.S. Application Publication No. US2002/0060034, (e) U.S. Application Publication No. US2007/0240841 (U.S. Pat. No. 7,918,966), (f) U.S. Pat. No. 3,104,197, (g) U.S. Pat. No. 3,220,116, (h) U.S. Pat. No. 3,266,972, (i) U.S. Pat. No. 3,269,393, (j) U.S. Pat. No. 3,908,071, (k) U.S. Pat. No. 6,024,832, (l) U.S. Pat. No. 6,458,447, and (m) U.S. Pat. No. 6,712,930, the disclosures of which are all incorporated by reference herein, as though recited in their entireties.

In some illustrative preferred embodiments, an extensible paper employed has an extensible range, as measured in a pre-slit configuration, of 3 to 20% in the machine direction. In some illustrative preferred embodiments, an extensible paper employed has an extensible range, as measured in a pre-slit configuration, of 3 to 15% in the machine direction. In some illustrative preferred embodiments, an extensible paper employed has an extensible range, as measured in a pre-slit configuration, of not less than 5% in both the machine direction and the cross direction. In some illustrative preferred embodiments, an extensible paper employed has an extensible range, as measured in a pre-slit configuration, of 3 to 20% in the machine direction. In some illustrative preferred embodiments, an extensible paper employed has an extensible range, as measured in a pre-slit configuration, of from 1-9% in a machine direction and 1-5% in a cross direction. In some illustrative preferred embodiments, an extensible paper employed has an extensible range, as measured in a pre-slit configuration, of from 3-9% in the machine direction and not less than 5% in the cross direction. In some illustrative preferred embodiments, an extensible paper employed has an extensible range, as measured in a pre-slit configuration, of 3-11.1% in the machine direction, or, in some embodiments of 3.3-10.6% in the machine direction.

In some preferred embodiments, the extensible paper is a non-woven fibrous material with fibre-to-fibre bonding that resists tearing upon 3-15% expansion in the machine direction as measured in a non-slit configuration.

In some preferred embodiments, the extensible paper is formed by being pre-compressed between two different members contacting opposite sides of the paper web. For example, in some embodiments, the extensible paper is formed by the paper web being pre-compressed between two different rollers having different roller surfaces and/or rotations, or the extensible paper is formed by the paper web being inserted between a roll and an endless pre-stretched blanket to compress the paper web with a nip bar and the blanket. In some preferred embodiments, the extensible paper is formed by being pre-compressed such as to create an extensible paper of a non-woven fibrous material with increased fibre-to-fibre bonding.

In the preferred embodiments, the term “stretching direction” refers to the direction in which a slit paper sheet is subjected to a pulling or stretching force. In the preferred embodiments, the stretching direction is transverse to the direction of the slits of the slit sheet material. In some preferred embodiments, the stretching direction is the machine direction.

In some preferred embodiments, an extensible paper can be formed using methods as described in U.S. Pat. No. 3,908,071, incorporated herein by reference in its entirety. For reference, the following is a direct quote of the paragraph on column 1, lines 4-19, of U.S. Pat. No. 3,908,071: “Extensible (compacted) paper produced, for example, in accordance with the apparatus and process disclosed in U.S. Pat. No. 2,624,245 has certain well recognized advantages and commercial uses. Such paper is subjected, while in a partially moistened condition, to compressive compaction in the direction of web movement (machine direction or MD) between a pressure nip, thus compacting and forcing the fibers together to produce an inherent stretchability without creping. Compacted paper has improved tensile energy absorption (TEA) burst and tear characteristics which are highly desirable for such end uses as the manufacture of paper sacks.”

In some preferred embodiments, an extensible paper can be formed using methods as described in U.S. Pat. No. 6,024,832, incorporated herein by reference in its entirety. For reference, the following is a direct quote of the Abstract of U.S. Pat. No. 6,024,832: “A method for producing extensible paper, comprising the following stages: feeding a mix of vegetable fibres to a kneader member, mixing the mix with water in the kneader, beating the fibres to obtain a pulp, transferring the beaten pulp into a flow chest, feeding the beaten pulp from the flow chest onto a paper web formation cloth with consequent reduction of the water percentage by gravity and vacuum, pressing the web, with consequent further reduction of its water content, initial drying of the paper web to a substantially constant moisture content of between 15% and 65%, compacting, final drying to a moisture content of between 15% and 4%, preferably 10%-8%, glazing, wherein: the beating stage is carried out by rubbing the fibres in a multistage unit to obtain a pulp having a degree of beating of at least 30.degree. SR, the compacting stage is carried out between at least a pair of rollers of which one is of hard material comprising circumferential surface ribs and driven at greater speed, and the other is of soft material with a smooth surface and driven at lesser speed.”

In some preferred embodiments, an extensible paper can be formed using methods as described in U.S. Pat. No. 9,945,077, incorporated herein by reference in its entirety. For reference, the following is a direct quote of the 2nd paragraph of the Background section of U.S. Pat. No. 9,945,077: “On the other hand, Clupak refers to equipment that inserts a paper web between a roll and an endless rubber blanket to compress the paper web with a nip bar and the rubber blanket, while at the same time the pre-stretched blanket shrinks to cause the paper web to also shrink and thereby increase its breaking elongation, and this equipment is used to provide increased breaking elongation to kraft paper used in heavy packaging applications as mentioned above.” For further reference, the following is a direct quote of U.S. Pat. No. 9,945,077, column 6, first paragraph: “The manufacturing method using this Clupak system is such that a paper web is inserted between a roll and an endless rubber blanket to compress the paper web with a nip bar and the rubber blanket, while at the same time the pre-stretched blanket shrinks to cause the paper web to also shrink and thereby increase its breaking elongation. The Clupak system allows for adjustment of the breaking elongation of kraft paper in the longitudinal direction according to the ratio of the manufacturing speed on the inlet side of the Clupak system and manufacturing speed on the outlet side of the Clupak system, and also according to the pressurization force applied by the nip bar.”

In some preferred embodiments, an extensible paper can be formed using methods as described in U.S. Pat. No. 3,104,197, incorporated herein by reference in its entirety. For reference, the following is a direct quote of the paragraph on column 2, lines 41-56 of U.S. Pat. No. 3,104,197: “The use of rubber or rubberous material in conjunction with a hard surface in the manner described is known in the treatment of paper as well as fabrics but only in a general way and the present invention includes the use of rubber considerably softer and more elastic than previously used. Also of great importance in the production of an extensible paper by creping it in this manner is the differential in speeds at which the rolls are driven. If the proper combination of hard and soft surfaces is provided, a semi-dry paper web passing through the nip of the rolls will be carried by the contracting rubber against the direction of web travel toward the nip and over the surface of the hard roll. This creates a uniformly compressed crepe in the paper web giving toughness, pliability, and extensibility.”

In the preferred embodiments, the term “extensible slit sheet paper” means a paper that is both extensible and expandable as disclosed in U.S. patent application Ser. No. 16/018,702 (U.S. Application Publication No. U.S. 2018/0370702, published Dec. 27, 2018), the entire disclosure of which is incorporated herein by reference.

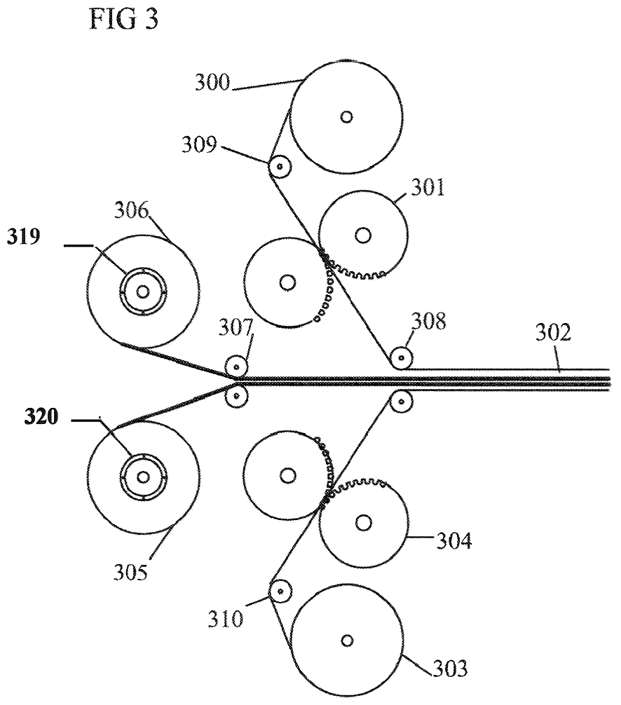

In the preferred embodiments, the term “embossed” means to raise and/or to lower a region of a sheet of paper. Most preferably, embossments involve raised and/or lowered regions of a sheet of paper which are raised and/or lowered by the application of a force such as to press the paper to assume an embossed shape in which the pressure causes deformation in the sheet of paper such as to have a shape including such raised and/or lowered regions. In some preferred embodiments, the sheet of paper is initially substantially planar and without the raised and/or lowered regions of the embossments in an initial state, and, then, the sheet of paper is pressed to cause deformation in the sheet of paper including raised and/or lowered regions. These raised and/or lowered regions from the original plane of the original planar sheet of paper are referred to, in the most preferred embodiments, as “embossed” regions or “embossments.” By way of example, in the most preferred embodiments, embossments are created by pressing an initial sheet (e.g., a planar or substantially planar sheet) between opposing pressing surfaces, such as, e.g., (1) between die plates that are reciprocated relative to one another to press the surface of the planar sheet, wherein the die plates have a pattern of raised and lowered regions (e.g., male and female regions) that create a cross pressure on the face of the planar sheet to cause the sheet to deform and form embossments and/or (2) between two rollers (such as, for example, as shown in the embodiment of FIG. 3) wherein the rollers have a pattern of raised and lowered regions (e.g., male and female regions) that create a cross pressure on the face of the planar sheet to cause the sheet to deform and form embossments. In some embodiments, embossments can involve pressure applied by a single reciprocated die plate that has a raised/lowered embossment pattern that presses against a first surface of the paper, while an opposite side of the paper is pressed or supported by a resilient (e.g., rubber) member that flexibly receives the raised and/or lowered portions to cooperative cause embossments in the paper sheet. Similarly, in some embodiments, embossments can involve pressure applied by a single roll die that has a raised/lowered embossment pattern that presses against a first surface of the paper, while an opposite side of the paper is pressed or supported by a resilient (e.g., rubber) roll member, or other surface member, such as a conveyor or other member, that flexibly receives the raised and/or lowered portions to cooperative cause embossments in the paper sheet

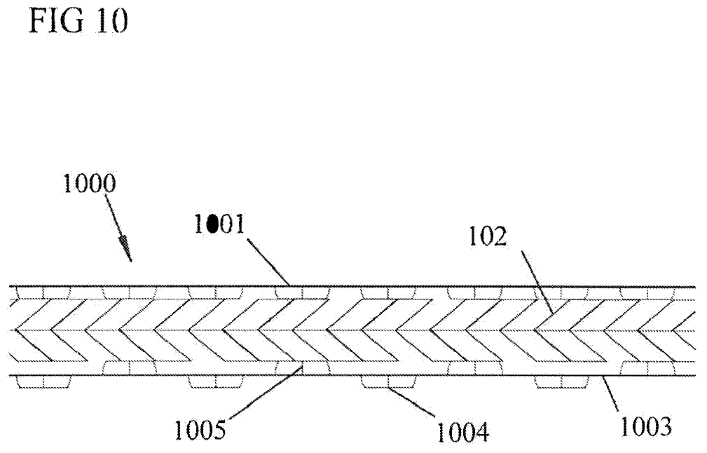

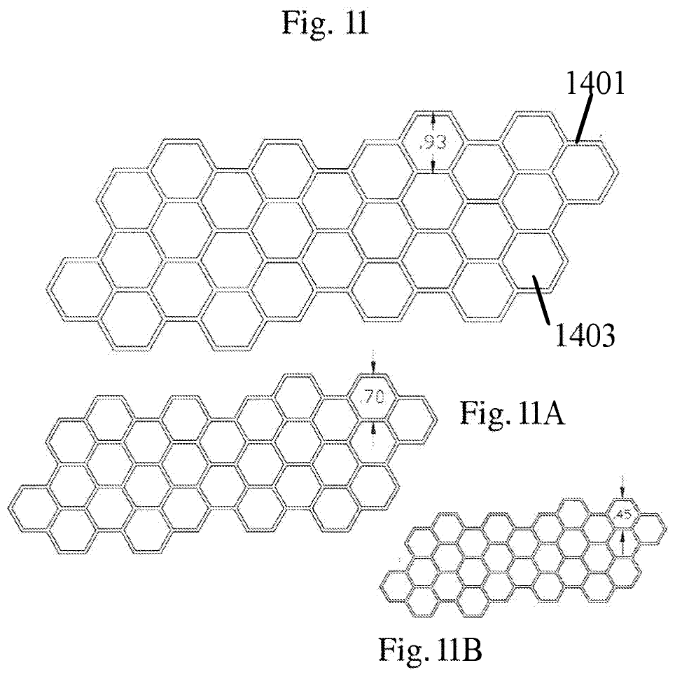

In some preferred embodiments, embossments are formed in a repeating pattern along a conveyed sheet of paper that is conveyed from an initial roll. In some preferred embodiments, the embossments define discrete shapes that are displaced from the original plane of the paper (e.g., raised and/or lowered) within separated regions along the face of the sheet of paper. In some preferred embodiments, these discrete regions can have an irregular shape, while in some embodiments, these discrete regions can have a circular shape, elliptical shape, oval shape, polygonal shape, triangular shape, square shape, pentagonal shape, hexagonal shape, octagonal shape and/or other shapes. In the most preferred embodiments, the embossments have a hexagonal shape. Here, the terminology “shape” of the embossments in the above paragraph refers to the shape of the embossments as viewed downwardly towards a face of the paper sheet. It should be understood that, as seen in a side view (such as, e.g., in side views similar to that shown in FIGS. 10 and 12-15, such embossments have a different shape).

In some preferred embodiments, the embossments can have a substantially flat or consistent peak height or displacement height from the original plane of the sheet of paper. For example, as shown in the above-noted FIGS. 10 and 12-15, the peak heights of the embossments are substantially consistent. In this regard, in the preferred embodiments, the peak heights of the embossments are preferably substantially consistent along and within each individual embossment. In addition, in the preferred embodiments, the peak heights of the embossments are preferably substantially consistent between a plurality of embossments, such that embossments extending in a certain direction (e.g., a raised direction or a lowered direction) have a substantially consistent peak height along the face of the sheet. In some embodiments, embossments can extend by raised and lowered and the peak heights can differ on each opposite side of the sheet, but are preferably substantially consistent on the respective sides of the sheet.

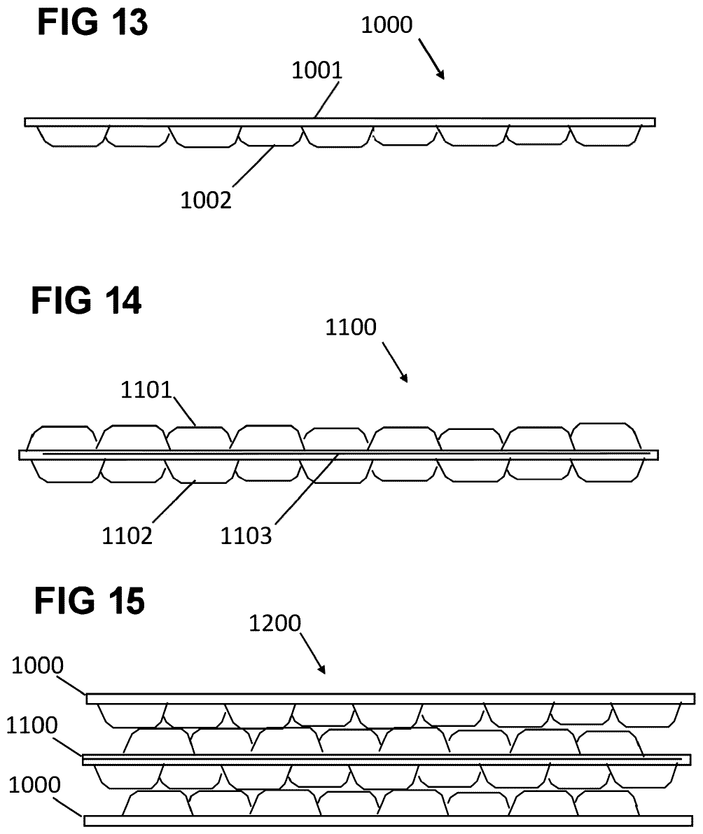

In addition, in some preferred embodiments, the peaks of the embossments are substantially planar or include a substantially planar central area which can taper or can be rounded at edges of the peaks of the embossments. Moreover, in some preferred embodiments the peripheries of the embossments preferably extend substantially transverse from the original plane of the paper sheet. This structure can be seen, e.g., in the above-noted FIGS. 10 and 12-15 by way of example. Moreover, in some embodiments the peripheries of the embossments that extend substantially transverse to the original plane of the paper sheet extend substantially perpendicular to the plane of the paper sheet. In some other embodiments, similar to that shown in FIGS. 13-15, the peripheries of the embossments that extend at an angle to the original plane of the paper sheet and be inclined towards the embossment region. In some embodiments, this angle of inclination can be as shown in various embossments in the figures. In some embodiments, this angle of inclination can be between about 45-90 degrees, or between 60-90 degrees, or between 70-90 degrees, or between 80-90 degrees. Some illustrative embodiments would have an angle that is between about 65-85 degrees.

In some embodiments, the embossments can be in a pattern (such as, e.g., an array) of embossments in which at least some of the embossments are discretely located in separate positions on the sheet of paper (e.g., such that discrete embossments are surrounded by portions having the original plane of the sheet of paper).

In some embodiments, the embossments can be in a pattern (such as, e.g., an array) of embossments in which at least some of the embossments are not entirely discretely located at separate positions on the sheet of paper. For example, in some embodiments, the embossments can be located adjacent one another, or can be connected together. For example, in some embodiments, thin or elongated or linear embossments (such as, e.g., raised rail-shape embossments or lowered groove-shape embossments can extend between embossed regions. However, in the most preferred embodiments, at least some, and preferably, most of the embossments would have peripheries that are largely surrounded by portions having the original plane of the sheet of paper. For example, in many cases, the peripheries of the embossments would mostly be surrounded by portions having the original plane of the sheet of paper.

In the preferred embodiments, embossments are applied to individual sheets of paper such as to create a pattern of embossment within the individual sheet of paper. In the preferred embodiments, embossments do not adhere multiple sheets of paper together. In the preferred embodiments, embossments create raised and/or lowered regions that, in fact, help to separate adjacent layers (e.g. adjacent layers of paper) by displacing the original plane of the embossed sheet from an adjacent sheet due to the added peak height of the embossments. In some embodiments where an embossed sheet is to be attached to an adjacent sheet, such attachment can be by gluing and/or otherwise attaching to the adjacent sheet. This is in contrast to use of techniques, such as, e.g., knurling, that can be used to attach adjacent sheets.

In some preferred embodiments, the term embossed includes raising and/or lowering a surface of a sheet of paper (e.g., Kraft paper) and encompasses recessed embossments, raised embossments, and an embossments that is both raised and recessed.

In some preferred embodiments, the term “recessed embossments” means to lower the surface (sunk-relief) of a sheet of paper (e.g., Kraft paper) relative to an adjacent layer.

In some preferred embodiments, the term “raised embossment” means to raise the surface of a sheet of paper (e.g., Kraft paper) relative to an adjacent layer.

In some preferred embodiments, an “embossed” region of a paper sheet includes a region of the paper sheet in which a plane of the embossed region of the paper sheet is displaced from a plane of a non-embossed region of the paper sheet adjacent to the embossed region of the paper sheet.

### DESCRIPTION OF THE PREFERRED EMBODIMENTS OF THE INVENTION (RELATED TO SER. NO. 16/870,195)

While the present invention may be embodied in many different forms, the illustrative embodiments are described herein with the understanding that the present disclosure is to be considered as providing examples of the principles of the invention and that such examples are not intended to limit the invention to preferred embodiments described herein and/or illustrated herein.

In the most preferred embodiments of the present invention, the invention employs “expanded slit sheet” material in combination with an exterior layer of “embossed” paper to produce a padded envelope with cushioning properties. In addition to the additional patent and other publications incorporated herein by reference in this application, the entire disclosures of U.S. Pat. No. 2,856,323, describing the manufacture of “embossed” paper, and of U.S. Pat. No. 10,226,907, U.S. Application Publication No. 2018/0222665, U.S. Application Publication No. 2018/0127197, and U.S. Application Publication No. 2018/0370702, describing “expanded slit sheet” manufacturing and designs, are all incorporated by reference herein as if recited in full.

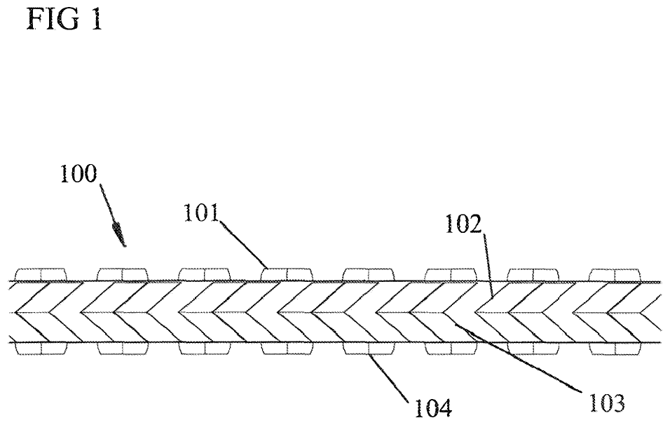

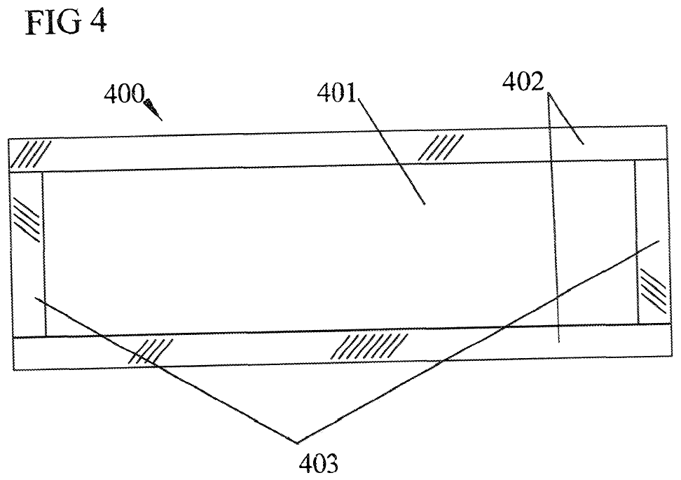

As shown in FIG. 1, the illustrated embodiment uses a four-layer composite starting with the first layer of embossed paper 104, laminated, on all edges (as shown in FIG. 4, reference numbers 402 and 403) to the two layers of expanded slit paper layers which can be, for example, as disclosed in U.S. Pat. No. 10,226,907, with a fourth top-layer of embossed paper. This produces a paper pad that is completely recyclable and that can be made mostly of recycled paper.

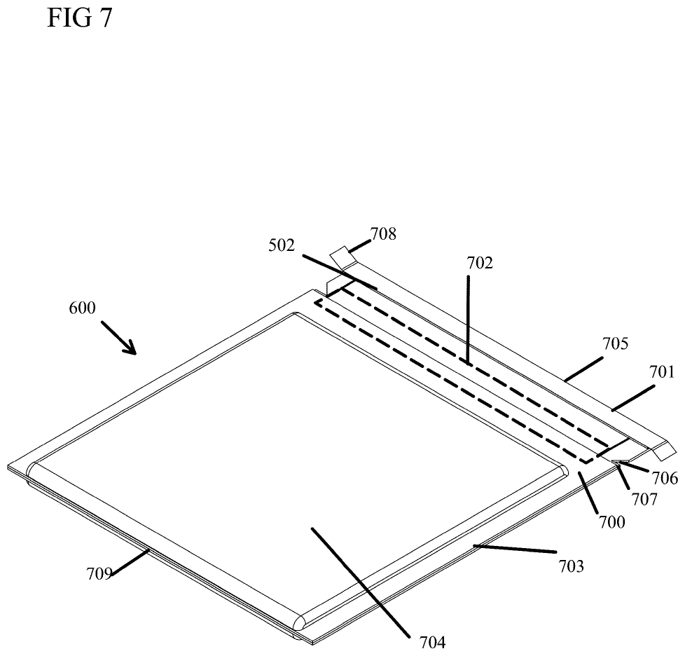

Following construction of the paper pad, in the preferred embodiments, two further steps are employed to make the envelope. The first is to fold the pad as shown in FIG. 7 so that a pouch area 704 is formed upon gluing together the laminated sides 703. Optionally, sides 703 can be crushed to provide rigidity and to flatten the side regions.

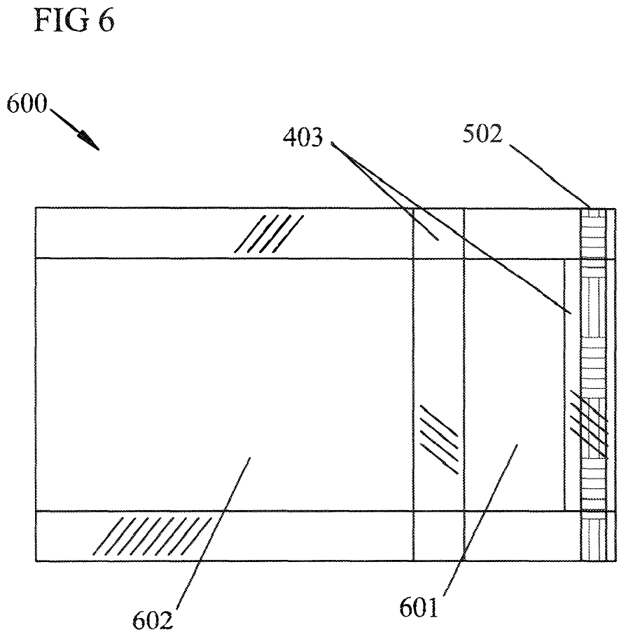

In the preferred embodiments, a double-sided adhesive strip 502 (as shown in FIG. 6) is provided with a release liner 701 (as shown in FIG. 7), which release liner 701 covers the adhesive strip 502 and is removable to expose the adhesive strip 502 for closing of the envelope.

With reference to the top view of FIG. 4, the middle area 401 is where the expanded slit sheet will be placed and will further be placed on the areas 403 and the areas of 403 will be laminated with a layer of paper which can be embossed, as taught hereinafter.

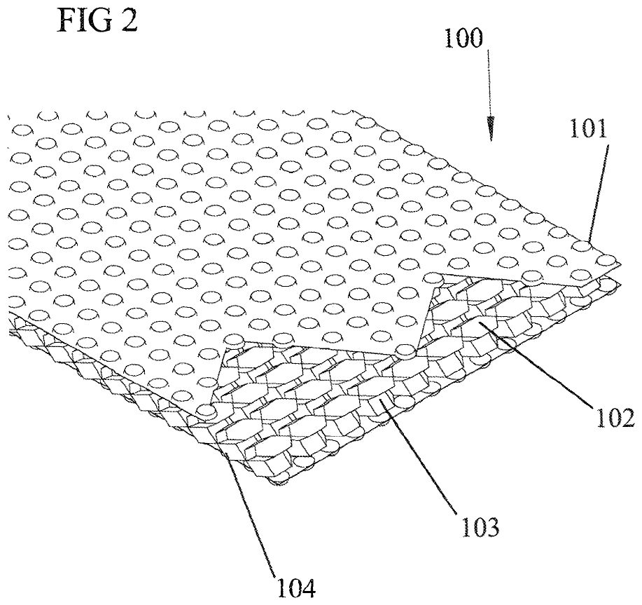

With reference to FIG. 2, in the preferred embodiment, the expanded slit sheets 102 and 103, as shown, are the full length but not the full width of the embossed paper 101 and 104. It is not necessary for the expanded layers to fully extend in width. However, the expanded layers fully extend the length in the preferred embodiment. Referring to FIG. 4, the adhesion areas 403 trap the expanded slit sheet paper in between the embossed outer layer and the inner layer to keep and maintain the expanded slit sheet expanded such as to provide the cushioning and total thickness that the expanded slit sheet has to offer. The inner layer can be flat or embossed as disclosed hereinafter.

Although two layers of expanded slit sheet material are shown in FIG. 1, other embodiments can employ different numbers of layers of expanded slit sheet material. The envelope of the preferred embodiments of the present invention can be made with a single layer, two layers (as shown), or even three or more layers of expanded slit sheet material. Additionally, in some embodiments, one or more or all of the layers of expanded slit sheet material can employ expanded slit sheet material of chaotic cell structure as disclosed in U.S. Application Publication No. 2018/0127197, the entire disclosure of which is incorporated herein by reference.

In the preferred embodiments, the pouch, within the constructed envelope, is used by placing an item or article for shipping within the pouch area 704 (as shown in FIG. 7). Then, after the item or article is contained within the pouch area, the envelope is closed by exposing the adhesive of the adhesive strip by removing the release liner 701 (such as, e.g., by manually grasping the extension tab 708 and laterally pulling the release liner across the width of the envelope) and then folding the top portion of the pad at a fold position 707 (e.g., a fold line) to place the top portion of the pad onto the pouch area and enable the adhesive strip 502 to seal the envelope 600 by adhering to an outer surface of the pouch area 704.

In some preferred embodiments, an embossed paper can be an embossed paper as found within the art (such as, e.g., embossed paper as described in all patents and publications discussed in this application, which are all incorporated herein by reference in their entireties), and in the preferred embodiments the embossed paper is made with a Kraft paper having a weight in the range from about 40 to about 60 pounds, as per the TAPPI standard paper weight specification of 3,000 square feet. Advantageously, a paper weight equaling the basis weight of 50 pounds plus/minus 10% enables the envelope to perform in ways that were previously unexpected.

In the illustrative embodiment shown in FIGS. 1 and 2, the embossed paper 101 is formed with embossments that are made by using matching male-female dies that are pressed together such as to press or punch embossments into the paper, such as, e.g., as described in U.S. Pat. No. 2,856,323 (the entire disclosure of which is incorporated herein by reference), which shows circular embossments. The embossments are preferably distributed such as to create a unique stiffening property, while still enabling the flexibility that is required for placing items within the pouch. In the most preferred embodiments, a plurality of hexagonal embossments are provided. In the embodiment shown in FIGS. 1 and 2, the embossments are formed within the outer layer 101 of the envelope. Additionally, in the embodiment shown in FIGS. 1 and 2, embossments are also formed in the inner layer 104 of the envelope. As described herein, in some preferred embodiments, embossments are only provided in the outer layer 101 of the envelope and not within the inner layer 104 of the envelope. Moreover, although preferred embodiments include embossments in the outer layer 101, some embodiments can omit embossments in the outer layer 101, while including embossments in the inner layer 104, while yet other embodiments can omit embossments in both the outer layer 101 and the inner layer 104.

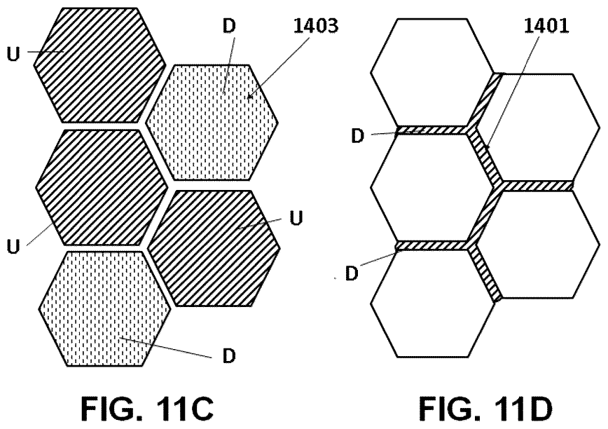

With reference to FIG. 11, this figure shows an illustrative embossment patterns that can be employed in some illustrative embodiments. In some implementations, an embossment pattern similar to that shown in FIG. 11 can be formed in a layer (such as, e.g., outer layer 101 and/or inner layer 104) by pressing a die configured to create an array of hexagonally shaped embossments. With reference to FIG. 11C, in some embodiments, each hexagonally shaped region 1403 (e.g., five such regions 1403 being shown for illustrative purposes in FIG. 11C) can be formed by a hexagonally shaped pressing member configured to be pressed into a paper sheet to create a hexagonally shaped embossment having a substantially or generally flat surface. Towards that end, the shaded regions in FIG. 11C (i.e., which shaded regions are within the hexagonally shaped regions 1403 in this example) represent embossments that are pressed such as to be displaced from the original plane of the paper sheet. In FIG. 11C, the white spaces between the hexagonally shaped embossments can be, e.g., at the original plane of the paper sheet.

In some embodiments, each of the hexagonally shaped regions 1403 are displaced from the original plane of the paper sheet in the same direction. For example, in some embodiments, all of the regions 1403 are displaced downwardly. In some other embodiments, all of the regions 1403 are displaced upwardly. In yet some other, and more preferred embodiments, some of the regions 1403 are displaced upwardly, and some of the regions 1403 are displaced downwardly. For example, in FIG. 11C, the regions 1403 shaded with an array of dashes are displaced downwardly as represented by the label D. On the other hand, in FIG. 11C, the regions 1403 shaded with diagonal lines are displaced upwardly as represented by the label U. In some embodiments, the variations in upward U and downward D displacements of the regions 1403 can be randomized. In some embodiments, the variations in upward U and downward D displacements of the regions 1403 can be in an alternating manner. In some embodiments, the variations in upward U and downward D displacements of the regions 1403 can be in a pre-set pattern.

Among other things, employing regions 1403 with both upward U and downward D displacements can substantially increase the strength and rigidity of the embossed layer. Additionally, by varying the directions of the embossments, less embossments can be formed to extend to a particular upward and/or downward side of the layer. Firstly, by extending some embossments in opposite directions, the number of embossments is necessarily less than if all embossments extended in a same direction. Secondly, by extending some embossments in opposite directions, a greater number of embossments can be set to extend in one direction than in the other direction. For example, in some embodiments, one side of the layer can have a lesser number of embossments so as to reduce a contact surface area in the event that an article or item is slid across the surface against the embossments. By way of example, this embodiment can be advantageous for reducing friction upon placing items within a pouch of the envelop by forming the inner layer 104 so as to have a reduced number of outwardly extending embossments, whereby a reduced contact surface area can be created to facilitate insertion and/or removal of items from within the pouch. For example, in the context of the insertion of flat articles or items (such as, e.g., paper or the like), a substantial decrease in contact friction can be achieved).

With reference to FIG. 11D, in some embodiments, rather than embossing across the entire areas of the regions 1403, embossment can be effected around the peripheries of such areas 1403. In particular, as shown in FIG. 11D, in some embodiments, the peripheral borderlines 1401 surrounding the hexagonal regions can be embossed. Towards that end, the peripheral borderlines 1401 that are shaded in FIG. 11D represent embossments that are pressed such as to be displaced from the original plane of the paper sheet. In FIG. 11D, the white spaces within the interiors of the hexagonal regions can be, e.g., at the original plane of the paper sheet.

Although the embodiment shown in FIG. 11D may have less structural rigidity that the embodiment shown in FIG. 11C, the embodiment shown in FIG. 11D can have some substantial advantages for some purposes. For example, as the “white regions” shown in FIG. 11D, which represent an original plane of the paper sheet encompasses a substantial majority of the surface and that substantial majority of the surface is at a substantially consistent height or substantially level, this embodiment can have substantial usefulness and advantage when such a substantially consistent or level surface is desired. For example, in some preferred embodiments, the outer layer 101 is embossed with an embossment patterns as shown in FIG. 11D. Among other things, having this embodiment pattern on an outer layer 101, an outer peripheral surface of the envelope (created by the outer layer 101) can be advantageously adapted to be able to receive a label (such as, e.g., an adhesive label), such as, e.g., a shipping label for using in shipping of the envelop. For example, such a label can include shipping information, such as, e.g., name and address of the intended recipient of the envelope, contents information related to the items contained within the envelop and/or other information related to the shipment or delivery of the envelope.

In some embodiments, such as, e.g., for use as an outer layer 101, the embossed peripheral borderlines 1401 of FIG. 11D preferably extend downwardly D (as shown in FIG. 11D). In this manner, the embossed region would not extend upwardly from the surface of the layer 101. Accordingly, the embossments would even more substantially avoid interference with the use of the outer surface of the outer layer 101.

In some implementations, an embossment pattern similar to that shown in FIG. 11 can be formed in a layer (such as, e.g., outer layer 101 and/or inner layer 104) by pressing a die having an array of protruding hexagonal shaped die press members that are each configured with a shape corresponding to the hexagon 1403 shown in FIG. 11. In some embodiments, the array of hexagons 1403 can, thus, be created by pressing the die against the layer for embossment (i.e., by sandwiching the layer between the die and a complementary shaped receiving die member placed on an opposite side of the layer being embossed).

For example, in some illustrative embodiments, an outer layer 101 can include an embossment pattern as shown in FIG. 11 in which the peripheral borderlines 1401 of the hexagons 1401 are recessed embossments (similar to that shown in FIG. 11D) and have a small depth. For example, in some embodiments, the depth can be less than 0.01″, and, most preferably, can be a depth of about 0.005″ (0.127 mm). In some illustrative embodiments, this depth value can be varied within a range about +/−50%, or, more preferably, within a range about +/−25%, or, mostly preferably within a range about +/−15%. Surprisingly, this small embossment pattern still provides a substantial resilience to the paper as well as a more luxurious and more protective feel and is highly advantageous as an outer layer 101. Moreover, in this latter embodiment, by having the embossment extend downwardly, the embossment substantially does not interfere with use of the paper for applying a label or other purposes.

As illustrated in the exemplary embossment patterns shown in FIG. 11, FIG. 11A and FIG. 118, in various embodiments the sizes or dimensions of the hexagonal regions 1403 can be varied depending on circumstances. For example, in the example shown in FIG. 11, a diameter or distance between opposite walls of the hexagon is about 0.93′ (i.e., inches), while in the example shown in FIG. 11A, a diameter or distance between opposite walls of the hexagon is about 0.70′ (i.e., 0.70 inches), while in the example shown in FIG. 118, a diameter or distance between opposite walls of the hexagon is about (i.e., 0.45 inches). While the diameters of such hexagonal regions 1403 can vary, in some embodiments, the diameter is preferably less than 2″, and, more preferably, less than 1.5″, and, more preferably, less than 1.0″.

Moreover, in some embodiments in which embossments are employed on the outer layer 101 and the inner layer 104, the diameters of the embossments between these layers can be selected differently. For example, in some preferred embodiments, the diameter of the embossments of the outer layer 101 is substantially larger than the diameter of the embossments of the inner layer 104. Among other things, employing larger diameter embossments in the outer layer 101, of the type shown in FIG. 11D further reduces the interference by the embossments. On the other hand, employer smaller diameter embossments in the inner layer 104, of the type shown in FIG. 11C can further reduce the surface area of the embossments such as to reduce friction when placing items within a pouch of the envelope, facilitating sliding of items into and out of the envelope.

In some most preferred embodiments, the inner layer 104 includes embossments of the type shown in FIG. 11C and the diameter across each hexagon 1403 is about 0.25″ wide. In addition, the embossments preferably alternate between upwardly and downwardly extending (i.e., male and female embossments).

In some most preferred embodiments, the outer layer 101 includes embossments of the type shown in FIG. 11D and the inside diameter of each hexagon between the inside of the peripheral borderlines at opposite sides of the hexagons is 0.75″. In addition, in the preferred embodiments, the outside diameter of each hexagon between the outside of the peripheral borderlines 0.875″ (i.e., such that the width of the peripheral borderlines (i.e., the width of the embossments) is thus 0.0625″. In other embodiments, the width of the peripheral borderlines (i.e., the width of the embossments) can be within a range of about 0.002′ to 0.25″.

As indicated above, In the most preferred embodiments of the present invention, the invention employs “expanded slit sheet” material in combination with an exterior layer of “embossed” paper to produce a padded envelope with cushioning properties. An additional benefit that the embossed paper provides, in combination with the expanded slit material, is that it provides the ability to hold the expanded slit sheet material in a stretched state (i.e., in which the expanded slit sheet paper has been expanded to open the cells and, thus, create a wider width with cushioning properties) and without creating wrinkles on the outer paper.

Notably, “expanded slit sheet” paper material not only requires a force to expand or stretch the paper, but such a paper also exerts a retraction force from a fully expanded state. In the context of this novel invention, in which an expanded slit sheet paper is preferably attached face-to-face with an outer layer of paper, the retraction force can have a tendency to cause the outer layer of paper to wrinkle due to insufficiency strength and rigidity to resist this retraction force of the fully expanded expandable slit sheet material. Additionally, as the retraction force of the expanded slit sheet paper is in a direction along the plane of the expanded slit sheet, when the expanded slit sheet is attached face-to-face with the outer layer, the retraction force will, thus, extend along the plane of the outer layer. As thin sheet material such as paper has limited rigidity along this direction, the retraction force can cause wrinkling and deformation of the outer layer.

Although heavier weight paper could be used in some embodiments to increase the rigidity sufficiently to avoid wrinkling and deformation of the outer layer (e.g., by using a heavy enough outer paper such that its rigidity imparts a greater force than the retraction force of the expanded slit sheet paper), this increased weight and stiffness of the outer layer has disadvantages. For example, the use of an outer layer with greater weight and stiffness adds to the postage costs (e.g., as postage costs are based on weight) and makes loading items within the pouch more difficult (e.g., as the flexibility of the envelope and, hence, the ability to “open” the pouch and insert items is hindered with increased rigidity of the paper, and also as heavier envelopes can be more difficult to manually manipulate in some contexts).

In some highly preferred embodiments, the expanded slit sheet paper can be formed in a novel manner to reduce the retraction force of the expanded slit sheet paper by employing a novel type of expanded slit sheet paper developed by the present inventor that involves the use of an “extensible” paper. As explained above, in the preferred embodiments, the term “extensible” as applied to paper sheets, includes a paper as set forth in the present inventor's co-pending U.S. patent application Ser. No. 16/018,702 (U.S. Application Publication No. 2018/0370702), entitled Extensible Paper and Its Use In the Production of Expanded Slit Packaging and Void Fill Products, the entire disclosure of which is incorporated herein by reference. The present inventor has discovered that an additional way of countering the wrinkling effect that the expanded slit material tends to create by the retraction forces of the expanded slit sheet material when the expanded slit tries to retract is to use extensible paper as found in the latter '702 application.

The present inventor has discovered that extensible expanded slit sheet paper requires approximately ⅓ of the total force required to stretch the expanded slit sheet material in comparison to a similar weight non-extensible paper with a similar slit pattern and. For example, an extendable slit sheet material made with Kraft paper can require a force of about 6 lbs to expand a sheet that is approximately 15.5″ wide, while a extensible expandable slit sheet paper of similar weight and slit pattern can require a force of only about 2 lbs to expand a sheet that is approximately 15.5″ wide. In some preferred embodiments, an extensible paper is employed for the expandable slit sheet material that requires an expansion force in the range from about 0.15 to 0.22 pounds per inch to expand the sheet. Notably, the retraction force of the expanded slit sheet from the fully expanded state correlates to this force required to expand the expandable slit sheet paper.

In some embodiments, a light weight non-embossed Kraft outer paper layer can be utilized where wrinkling is not of concern and/or where the envelope is not used for individual shipping and durability is not of as much concern. In this latter case, the envelope can, for example, be used within and as part of a consolidated shipment that requires an outer box or container (such as, e.g., a corrugated box) or for in-the-box shipping, such as, e.g., wherein the envelope is contained within another box or container along with additional items to be shipped. This type of shipment does not require a durable anti-rip layer. In the context of use of the envelopes for in-the-box shipments or the like, a lighter weigh paper can be used, such as, e.g., a 40# or less Kraft paper for such in-the-box shipments, or, in some embodiments, even a 30# Kraft paper for such in-the-box shipments or even less

In some embodiments, the outer layer can employ an anti-rip paper, such as an anti-rip flat Kraft paper comprising a thicker paper, such as 60# or more Kraft paper that inhibits tearing.

An additional benefit of the embossed paper in combination with the expanded slit material is the increased packaging protection that it provides. Expanded slit paper, although extremely protective as a wrap, must be placed inside an enclosure or container to provide the cushioning. The embossed paper's bulk mimics a very light duty corrugated box with a slight undulating thickness that is, thus, thicker than non-embossed paper. For example, in some illustrative embodiments, the undulating thickness due to the embossments can be approximately three times the thickness of paper without such embossments. In other embodiments, the undulating thickness can be greater than 3 times the thickness of the paper, such as, e.g., 4 times the thickness, or 5 times the thickness or even more. In preferred embodiments, the undulating nature of the embossments can operate much like the sine wave of the inner layer found within a corrugated box. Among other things, this can also help provide an initial shock protection that even further inhibits tearing that can occur with smooth (non-embossed) papers.

An additional benefit of the use of an embossed outer layer for envelope is the increased ability to manually hold the envelope by hand securely or even by conveying equipment because the embossments can add to the friction between the envelope and a user's hands or between the envelope and conveying rolls or equipment for easy handling or processing as compared to smooth (non-embossed) papers and plastic.

The accompanying figures set forth details on relation to some preferred, and non-limiting, embodiments of the inventions.

FIG. 1 is a side view of the paper cushioning or padding material 100 according to some embodiments that employs double-cross layering of expanded slit sheet materials, as found in non-provisional patent application Ser. No. 14/480,319 (U.S. Pat. No. 10,226,907), the entire disclosure of which is incorporated herein by reference. In particular, as shown in FIG. 1, in this example, two layers of expanded slit sheet papers 102 and 103 are sandwiched between an outer layer 101 of paper and an inner layer of paper 104. As illustrated by the inclined lines within regions 102 and 103, in such double-cross layering embodiments the expanded sheets have cells with walls that incline in opposing direction, such as to, e.g., help limit nesting of the two layers 102 and 103. Specifically, as shown in FIG. 1, the expanded slit paper 102 is inclined rightwardly (i.e., faces forward) and the expanded slit paper 103 is inclined leftwardly (i.e., facing backward) and are sandwiched between embossed papers 101 and 104.

Although the embodiment shown in FIG. 1 includes two layers of expanded slit sheet paper, in some embodiments three or more layers of expanded slit sheet paper are employed. However, in some of the most preferred embodiments, only a single layer of expanded slit sheet paper is employed, which single layer preferably includes layers 101 and 104 along opposite faces of the single layer of expanded slit sheet paper. In some preferred embodiments, the expanded slit sheet paper adjacent the layer 101 contacts the layer 101, and the expanded slit sheet paper adjacent the layer 104 contacts the layer 104. Alternatively, in some embodiments, one or more intermediate layer could be inserted therebetween.

FIG. 2 is a perspective view of the paper cushioning or padding material 100 shown in FIG. 1, with portions removed to facilitate reference. As shown, the layers 101 and 104 are the embossed outer paper layers (also referred to as outer layer 101 and inner layer 104 in the context of formation of an envelope by folding of the padding material 100, and the expanded slit sheet layers 102 and 103 are located between these outer layers as described above.

Although the padding material can be made in a variety of ways, FIG. 3 is a schematic side view of an illustrative and preferred pad making process wherein Kraft paper rolls 300 and 303 are fed, respectively, to idler rollers 309 and 310 and then fed, respectively, through the embossment dies pairs 301 and 304 and around idler rolls 308 making the outer layers of the padding material shown in the combining area 302 of FIG. 3. As shown, unexpanded slit material rolls 305 and 306 are fed between a pair of Velcro rolls 307 and are together stretched using respective braking mechanisms 320 and 319 that slow the unwinder to allow for stretch and continues to the combining area 302.

As discussed above, FIG. 4 is a top view of the areas of the composite of embossed and expanded slit material 400 after opposite edges 402 and 403 have been connected to form a composite structure. In some preferred embodiments, the edges 402 and 403 are laminated together between laminating pressing wheels. In the preferred embodiments, the expanded slit paper (which is not seen in FIG. 4 because it is internal (e.g., obscured by the outer layer of embossed paper) is located within the area of 401.

Additionally, in the preferred embodiments, the expanded slit sheet paper is contained within the area 401 without being adhered or affixed to the composite material 400 along the edges 402 at the lateral sides of the expanded slit sheep paper material. In particular, the expanded slit sheet material is preferably only adhered to the composite material 400 at the opposite ends of the expanded slit sheet material, and, preferably, is only adhered at the edge regions 403. In this manner, the expanded slit sheet material preferably freely extends throughout the interior area 401 in a manner to be relatively movable with respect to the outer layers 101 and 104, except at the ends of the expandable slit sheet material which are fixed within the edge regions 403 by being crushed and glued and adhered to the outer layers 101 and 104 within the edge regions 403.

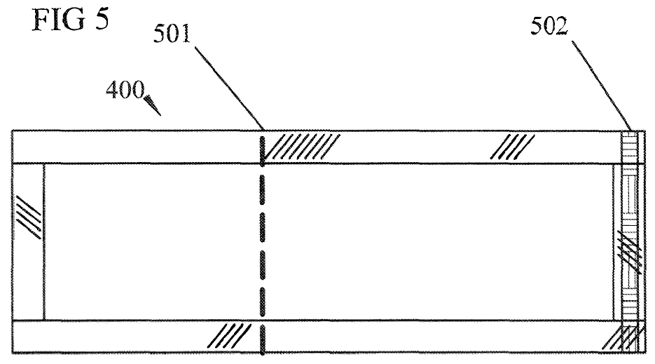

With reference to FIG. 5, FIG. 5 is a top view of the composite material 400 showing a dotted line 501 that represents a folding region for folding the material 400 to make the pouch. In the preferred embodiments, a double sided adhesive 502 is placed on the leading edge of the pad (which is to be covered by a release liner 701 as discussed below), which adhesive is later used to seal a pouch of the finally constructed envelope during use of the envelope.

With reference to FIG. 6, FIG. 6 is a top view of the padded envelope 600, after the composite material 400 shown in FIG. 5 has been folder over the folding line. As indicated above, the double sided adhesive 502 is located within the laminated edge 403 on the leading edge to provide adhesive for the envelope to close. As shown in FIG. 6, the extension portion or open area 601 is a fold-over flap portion that is folded over and adhered to the outer surface of the envelope via the adhesive 502 for closing of the envelope. In some preferred embodiments, the expanded slit sheet paper within the flap portion 601 is crushed so as to provide a thin and rigid flap to facilitate manipulation and use. However, in some embodiments, the flap portion 601 can include expanded slit sheet paper within this region in an expanded state for cushioning. For example, in some embodiments, the cushioning within the flap portion 601 can be sized so as to extend entirely over the crushed and laminated region 403 proximate the mouth of the pouch, such as to provide an extra length for cushioning the envelope over the crushed and laminated area 403 (i.e., as the region 403 is preferably crushed and laminated, the region 403 is flattened and does not have cushioning properties offered by the un-crushed expanded slit sheet paper.

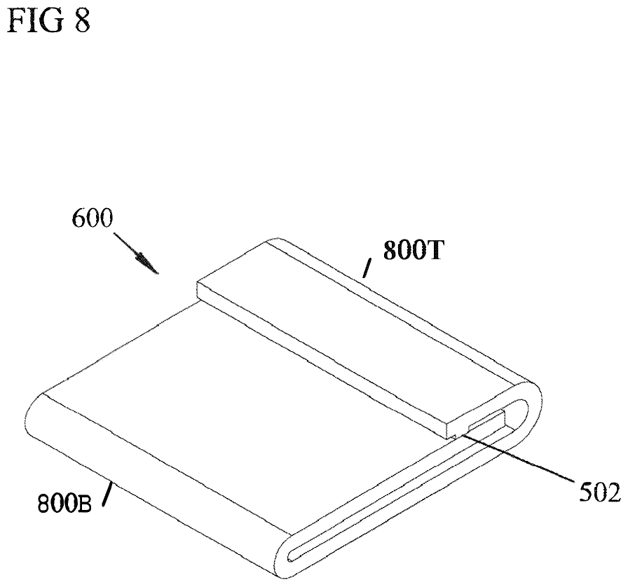

As discussed above, the double-sided tape 502 can be used to adhere the fold over flap portion to the outer surface of the envelope, and preferably the adhesive of the tape 502 adheres to the outer face of the envelope to the left side of the region 403 shown in FIG. 6 (i.e., at a side of the region opposite to the mouth of the pouch). For reference, FIG. 8 shows the envelope in a state in which the adhesive 502 is adhered to the front of the envelope just beyond the region or area 403 after the flap portion is folded over.

With reference to FIG. 7, FIG. 7 is a perspective view of the envelope 600 of FIG. 6 in the open position with double sided tape 502 is covered by a release liner 701. In FIG. 7, the edge regions 703 (i.e., which are along opposite sides of the envelope) correspond to the regions 402, which have been folded over and adhered to form the edge regions 703. For example, the regions 402 can be folded over and crush-glued or otherwise adhered together to form the edge regions 703.

With reference to FIG. 7, the region 705 corresponds to the edge region 403 formed at the end of the extending flap portion 601 shown in FIG. 6. In some embodiments, the adhesive or adhesive tape 502 can cover an entire area of the edge region 403 or, as shown in FIG. 6, the adhesive 502 can cover a portion of the edge region 403 formed at the end of the flap portion. In the embodiment shown in FIG. 7, the edge 705 corresponds to the edge region 403 at the end of the flap portion shown in FIG. 6. However, in FIG. 7, the adhesive 502 and the release liner 701 cover the entire edge 705.

In some embodiments, in order to form the pouch of the envelope, the composite member 400 shown in FIG. 5 is folded over the fold line 501 shown in FIG. 5. In some preferred embodiments, in order to facilitate folding of the composite material at the fold line 501 in order to form the pouch, a line of glue is extended across the width along the fold line in order to glue together the expandable slit sheet material with the outer layer 101 and the inner layer 104 along a narrow line along the fold line. For example, in some embodiments a narrow bead line of glue is applied to facilitate folding at the fold line 501. In some alternative embodiments, the expanded slit sheet paper is not glued along the fold line 501, such that the expanded slit sheet material can freely move relative to the outer layers 101 and 104 proximate to the folding line 501.

In some most preferred embodiments, the expandable slit sheet material within the flap portion 601 is crushed and not within an expanded state. Notably, in the more preferred embodiments, the entire flap portion 601 can be in a compressed state. However, in some embodiments, a least some or all of the expandable slit sheet material within the flap portion 601 can be in an expanded state. For example, in some embodiments, the expanded slit sheet material can be in an expanded state within the flap portion 601 up to the edge 403 shown in FIG. 6 or, similarly, up to the edge 705 shown in FIG. 7.

In the embodiment shown in FIG. 7, the envelope includes edge areas of crush-glue adhesion at the regions 703 and the edge 705, which surround a pouch area 704. Although the regions 703 and 705 can be formed in a variety of ways, the regions are preferably formed by pressing between opposite pressing members along with gluing to retain the regions in a compressed (e.g., thin) and adhered state. For example, such regions can be formed using pressure rollers, reciprocated pressing elements and/or other mechanisms. In the preferred embodiments, a glue that is employed in areas of the crush-glue adhesion (such as, e.g., in the regions 703 and 705) hardens to provide increased rigidity and/or stiffness. For example, this can help to create a more rigid or a stiffer flap portion 601.

In some embodiments, in addition to employing glue within the regions 703 and 705, other portions of the flap portion 601 can include be glued similar to the regions 703 and 705 (e.g., to create a more rigid or a stiffer flap). However, in the most preferred embodiments, at least a region 702 (shown representatively in dashed lines in FIG. 7) which is in the vicinity of the mouth of the pouch 704 (i.e., at folding-line position of the flap portion 601) is free from adhesives or gluing.

As shown in FIG. 7, the region 700 corresponds to the region 403 shown in FIG. 6 which is formed along the edge of and delineates the mouth of the pouch. In some preferred embodiments, as shown in FIG. 7, the non-glued region 702 overlaps the side-end of the region 700, such as to extend partly within the pouch and partly outside of the pouch within the flap portion 601. In particular, by ensuring that this region is free of glue, the flap portion 601 can be more certainly and effectively folded over around a fold line within the region 702 for improved operation and functioning of the envelop. In some embodiments, in order to facilitate folding over a fold line within the region 702 a crease can be formed across the width of the region 702 which can help facilitate folding.

The present inventor has discovered that providing a glue free area 702 in the region of the fold, optimizes the folding without adversely affecting the advantageous rigidity of the flap. The unglued area 702 within the fold over area, thus, can facilitate the folding over of the closure flap. In some preferred embodiments, the non-glued area 702 preferably extends across the entire width of the envelope and preferably extends a length of less than about % inch in the expansion direction of the expandable slit sheet paper (i.e., a direction along the length of the envelope perpendicular to the width of the envelope), and in some more preferred embodiments, the non-glued area 702 extends less than about ⅓″ in the expansion direction, and in a preferred embodiment, the non-glued region 702 extends in the expansion direction about ¼″ plus or minus 15%, and, in a most preferred embodiment, preferably ¼″ plus or minus 5%. In some preferred implementations, this equates approximately with the non-glued area 702 preferably being about 0.64 cm (plus or minus 15%) and, most preferably, about 0.64 cm (plus or minus 5%).

As discussed above, with reference to FIG. 7, reference number 703 indicates the glued envelope edges. Additionally, as discussed above, in some preferred embodiments, the slit sheet material is advantageously held in place only at the ends of the expandable slit sheet—and, in particular, at the top area 700 and at the region 705 which is beneath the release liner 701.

As also shown in FIG. 7, the release linear 701 which extends over and covers the adhesive 502 preferably includes at least one extension tab 708 that extends from an end of the adhesive 502 and which can be manually grasped by a user in order to pull the release liner from the adhesive 502. In the embodiment shown in FIG. 7, extension tabs 708 are shown at both ends of the release liner 701. However, in some embodiments, an extension tab 708 can be located at only one end. Additionally, in other embodiments, other mechanisms can be employed to facilitate manual removal of the release liner 701 and/or an extension tab or portion of the release liner can extend in different directions (e.g., extending towards or away from the mouth of the pouch, rather than laterally to the sides of the envelope as in the illustrated embodiment).

In some preferred embodiments, although the region 702 is free from glues or adhesives, the expanded slit sheet paper within the region 702 can be in a crushed state so as to have a smaller width so as to facilitate folding of the flap portion to close the mouth of the pouch. In some alternative embodiments, however, a portion of the flap portion 601 that extends between the distal end of the region 702 (i.e., the end of the region 702 closest to the distal end of the flap 601) and the edge region 705 includes expanded slit sheet paper in an expanded state, such that upon folding over the flap, the region 700 is covered by a cushioning created by this expanded slit sheet paper in an expanded state.

However, in some most preferred embodiments, the expandable slit sheet paper that is located within the entire flap portion 601 is in a crushed state, including the expandable slit sheet paper within the entire region 702 and within the entire region between the distal end of the region 702 and the edge region 705. In this manner, the entire flap portion 601 can, most advantageously, be more easily manipulated during use and closure of the envelope. Moreover, although the region 702 preferably is non-glued to facilitate folding of the flap portion, other portions of the flap portion can include glue such that the flap portion 601 can be advantageously more rigid and more easily manipulated during use.

As discussed above, FIG. 8 is a perspective view of a closed envelope 600 showing, e.g., double sided tape 502 affixing the envelope in a closed configuration (i.e., after removal of the release liner and closing of the pouch). In FIG. 8, the crushed sides (e.g., 703) shown in FIG. 7 are not depicted in FIG. 8 in order to help demonstrate the thickness of the pouch and the protection that the envelope provides and also to help demonstrate the bottom fold-over end 800B and the top fold over end 800T that both provide a generous internal pouch area (e.g., to help enable larger sized items to be placed within the envelope). Notably, although the lateral sides of the pouch are flanked by the crushed sides 703, as shown in FIG. 8, the bottom end 800B is preferably free from a crushed edge that would otherwise take-up or limit internal space within the pouch. Similarly, the top end 800T is preferably free from a crushed edge that would otherwise take-up or limit internal space within the pouch.

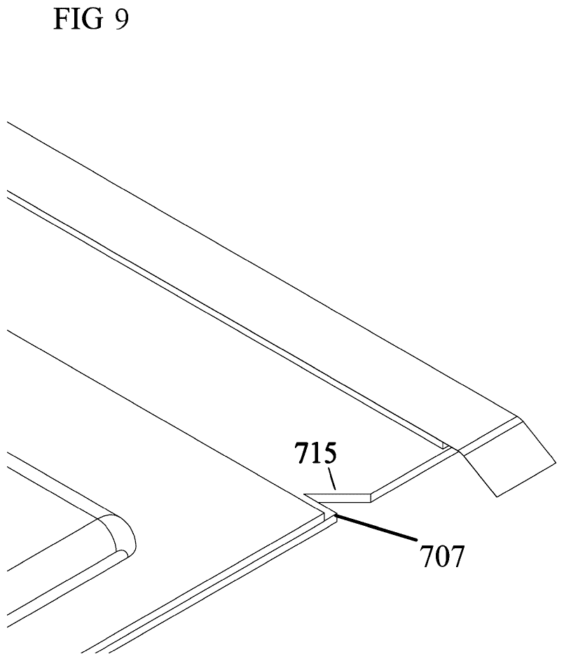

As shown in both FIGS. 7 and 9, in the preferred embodiments, in order to facilitate opening of a sealed envelope, the top end 800T of the envelope preferably includes a tear-open mechanism. Although a variety of tear open mechanisms can be employed in various embodiments, such as, e.g., a tear-string that is pulled laterally across the top end 800T and/or another tear-open mechanism, in some preferred embodiments, the tear open mechanism includes at least one lateral side notch 706 that is configured to facilitate manual opening or tearing of the top end 800T. As shown in FIG. 7, in the preferred embodiment, two lateral side notches 706 are provided, with a notch located at each lateral side of the envelope 600.

As shown in FIG. 9, each notch 706 is preferably located on the flap portion 601 at a base end the flap portion 601 that is aligned directly at or closely adjacent the outer end of the region 700 at the mount of the pouch. In the preferred embodiments, each notice 700 is a substantially V-shaped cut-out from a lateral side edge of the flap. IN some preferred embodiments, a base-side-edge 707 of the notch is formed so as to extend substantially parallel to the outer end of the region 700 such as to extend parallel to the mouth of the pouch in a widthwise direction across the envelope, and a front-side-edge 715 that extends forwardly at an acute angle to the base-side edge Notch 700 and back to the lateral side edge of the flap 601. In some preferred embodiments, the acute angle can be between about 20 to 50 degrees, and, in some more preferred embodiments, the acute angle is between about 25 to 45 degrees, and, in some more preferred embodiments, the acute angle is between about 30 and 40 degrees, and in some most preferred embodiments, the acute angle is about 35 degrees.

In some illustrative embodiments, the base-side-edge 707 of the notch has a length of between about ⅛ inch to about ½ inch, and, in some more preferred embodiments, a length of less than about ⅓ inch, and, in some more preferred embodiments, has a length of about ¼ inch. As best shown in FIGS. 6 and 7, in the preferred embodiments, the lateral side edges of the envelope are sealed together, such as, e.g., by being glued and pressed. As a result, the lateral side edges of the envelope, including along lateral sides of the flap portion shown in FIGS. 6 and 7 include these sealed lateral side edge portions. As a result, these lateral side edge portions can interfere with tearing or opening of the pouch. Accordingly, in the preferred embodiments, the notches 706 preferably are provided to facilitate opening of the pouch despite the sealed lateral side edges. Accordingly, in some preferred embodiments, the notch 706 is configured to extend a sufficient distance across the width of the lateral side edge to a) facilitate initiating of tearing and b) to avoid having to tear through a large extent of the lateral side edge portion. In some illustrative examples, the notch extends at least ¼ way across a width of the lateral side edge (e.g., edge 402), or in some preferred embodiments at least ⅓ way across a width of the lateral side edge, or in some preferred embodiments at least ½ way across a width of the lateral side edge, or in some preferred embodiments almost entirely or entirely across the lateral side edge portion.

In the preferred embodiments, the notch 706 is located within or adjacent the region 702. In addition, in some preferred embodiments, the region 702 include some weakening mechanism to facilitate lateral tearing of the flap from the location of the notch 706.

With reference to FIG. 10, FIG. 10 shows other illustrative embodiments of a composite material for forming an envelope. As explained above, in various embodiments, inner and outer layers of a composite material for forming an envelope can include a variety of different embossment structures. In the illustrative example shown in FIG. 10, the outer layer 1001 is provided with a pattern or array of downwardly extending embossments. As indicated above, in some preferred embodiments, these downwardly facing embossments help to achieve a substantially even outer surface that can, e.g., facilitate placement or adhesion of a label (e.g., a shipping label) to an exterior of the envelope. Notably, this embodiment is similar to the embodiment described above with respect to FIG. 11D.

Additionally, in FIG. 10 the inner layer 1003 in this embodiment can include a plurality of upwardly facing embossments 1005 and downwardly facing embossments 1004. Notably, this embodiment is similar to the embodiment described above with respect to FIG. 11C. Among other things, this embodiment can help to increase strength and rigidity and can also help to reduce or inhibit friction applied to items as they are inserted into or remove from the pouch (as described above). Additionally, this inner layer 1003, thus, provides a layer with two-sided embossments. Among other things, this provides a thick embossed layer made from a thin, flat, paper sheet, and, therefore, also advantageously provides additional cushioning.

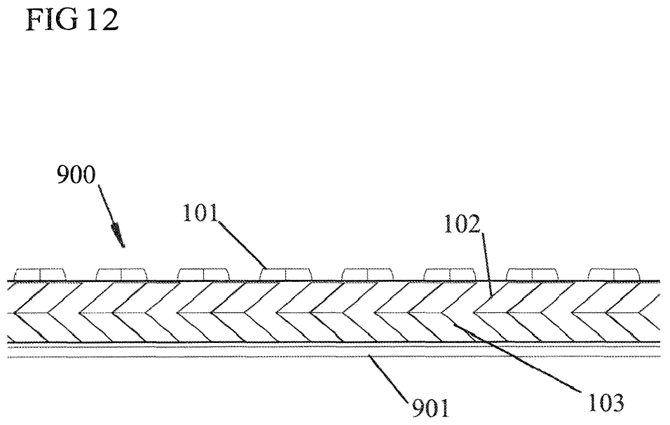

With reference to FIG. 12, FIG. 12 illustrates another illustrative embodiment of a composite material 900 for forming an envelope. In this illustrative embodiment, the outer layer includes a pattern of upwardly extending embossments 101. Moreover, in this embodiment the inner layer 901 is a smooth non-embossed layer. Among other things, providing a non-embossed or smooth inner layer can facilitate in some circumstances with insertion and removal of items to or from the pouch of the envelope.

With reference to FIGS. 13-15, these figures illustrate another illustrative embodiment of a composite material 1200 (shown in FIG. 15) for forming an envelope according to some illustrative embodiments. In the illustrative embodiments shown in these figures, rather than employing an expandable slit sheet material (such as, e.g., instead of using one or more layers of expandable slit sheet material, such as, e.g., layers 102 and/or 103 as shown in FIG. 1) that is placed between outer layers, the embodiment shown in FIGS. 13-15 employ a novel embossed cushioning layer between two outer layers. Although a specific arrangement of embossed layers is shown in FIG. 15, with an outer layer 1000 having downwardly extending embossments, and inner layer 1000 having upwardly extending embossments, and a middle layer with embossments extending both upwardly and downwardly (such as, e.g., to act as a cushioning layer), it should be appreciated that the outer layer 1000 and the inner layer 1000 of this embodiment can be modified similar to other embodiments described herein. Similarly, the inner layer 1100 can be modified to include other embossment patterns according to other embodiments described herein.

In this illustrative embodiment, FIG. 13 shows an illustrative embossed paper sheet 1001 having a pattern of embossments 1002 (such as, e.g., an array of circular, polygonal and/or other shaped embossments), extending therefrom in a single direction. As shown in FIG. 15, in this illustrative embodiment, the layer 1000 can be employed to form both the outer layer and the inner layer. By way of example, in some preferred embodiments, a similar layer 1000 can be arranged as an outer layer with the embossments facing downwardly, and a similar layer 1000 can be arranged as an inner layer with the embossments facing upwardly. As illustrated in FIG. 15, in the preferred embodiments in which embossments also provide a cushioning function, the embossments of the outer layer 1000 are distributed in such a manner such that when the layer 1000 is employed as an outer layer with downwardly facing embossments, the peaks of at least some of the embossments will contact the peak of at least some of the upwardly extending embossments of the middle layer such as to maximize thickness. Similarly, the embossments of the outer layer 1000 are distributed in such a manner such that when the layer 1000 is employed as an inner layer with upwardly facing embossments, the peaks of at least some of the embossments will contact the peak of at least some of the downwardly extending embossments of the middle layer such as to maximize thickness.

As shown in FIG. 14, in the preferred embodiments, at least one layer is employed that an undulating two-sided pattern layer 1100 which increases the final thickness of the embossed sheet.

In various embodiments described herein, the embossments can have depths of varying degrees depending on circumstance. In some embodiments, embossments can vary in overall thickness between about 0.01 and 0.19 inches. Among other potential advantages, the embossments can provide flexibility for ease of loading the items into an envelope for shipping and the varying thicknesses of cushioning layers provide additional cushioning protection.

In various other embodiments of the invention, other types of paper cushioning materials can be employed in combination with the outer embossed paper. Although these paper cushioning materials may provide less cushioning than a slit sheet layer, some embodiments can still employ such other paper cushioning materials. For example, such other embodiments can be desirable if a thinner product is desired and/or if less cushioning is required. The resultant thinner envelope reduces the cost for shipping by being able to place more envelopes within the same size container. The thinner composite design can provide an anti-tear design where no cushioning in required. These environmentally friendly, all-paper envelopes and pads, can replace plastic envelopes that by way of comparison provide little or no cushioning. Below are examples of other paper cushioning materials that can be employed in some illustrative examples.

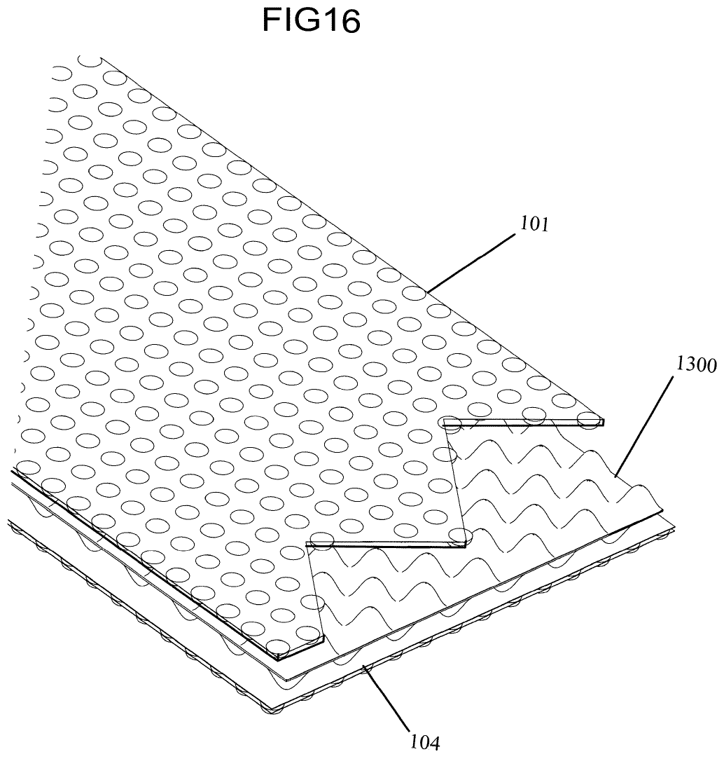

With respect to FIG. 16, FIG. 16 shows an embodiment that includes an outer layer 101 having an array of downwardly facing circular embossments, and an inner layer 104 that also includes an array of downwardly facing embossments. In this illustrative embodiment, an intermediate paper layer 1300 can be provided that includes an undulating sheet of paper. In this manner, the interior paper can operate to provide an cushioning quality similar to that employed in other embodiments described above.

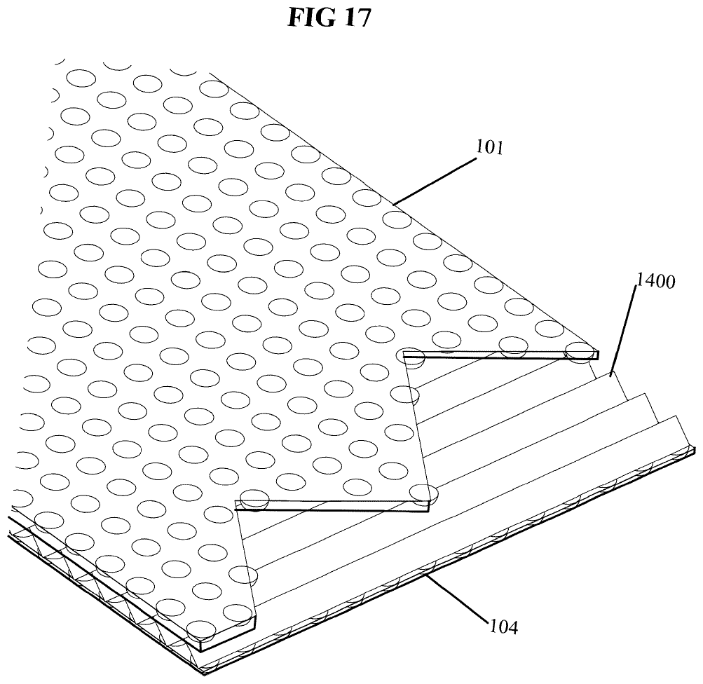

With respect to FIG. 17, FIG. 17 shows an embodiment that includes an outer layer 101 similar to that shown in FIG. 16, as well as an inner layer 104 that is similar to the inner layer 104 shown in FIG. 16. However, the embodiment shown in FIG. 17 employs an intermediate paper layer 1400 that is a pleated layer. In various embodiments, the cushioning that is provided by such a pleated paper varies based on the thickness of the pleated layer, as well as the pleat leg length and heights of the pleats, and the angles of the pleats. In some implementations, this can provide less flexibility where thinner items are to be packed and are not fragile. As shown in FIG. 17, the pleated layer 1400 is tall with an apex angle of approximately 90 degrees. In various embodiments, the pleat height can be reduced by increasing the apex angle in the range of 105-165 degrees thus increasing cushioning and flexibility, as desired. In embodiments employing a composite material similar to that of this embodiment, an envelope could be configured that is somewhat flexible in the long direction and firmer in the direction of the envelope opening. In some illustrative embodiments, the pleated embodiment diverges from the prior art of pleated paper packaging found in U.S. Pat. No. 6,871,480, and U.S Publication Nos. 2014/016666A1 and 2009/0233023A1, which are all incorporated herein by references as if recited in full.

U.S. Pat. No. 6,871,480 teaches the use of tissue paper adhered to the apices of the pleated sheet with a steep angle for stiffness as a wrapping product that is significantly taller to create a cushioning barrier. On the other hand, in some preferred embodiments of the present invention, wider pleat angles than taught in U.S. Pat. No. 6,871,480 are preferably employ, and preferably it is laminated only around the edges to the embossed paper.

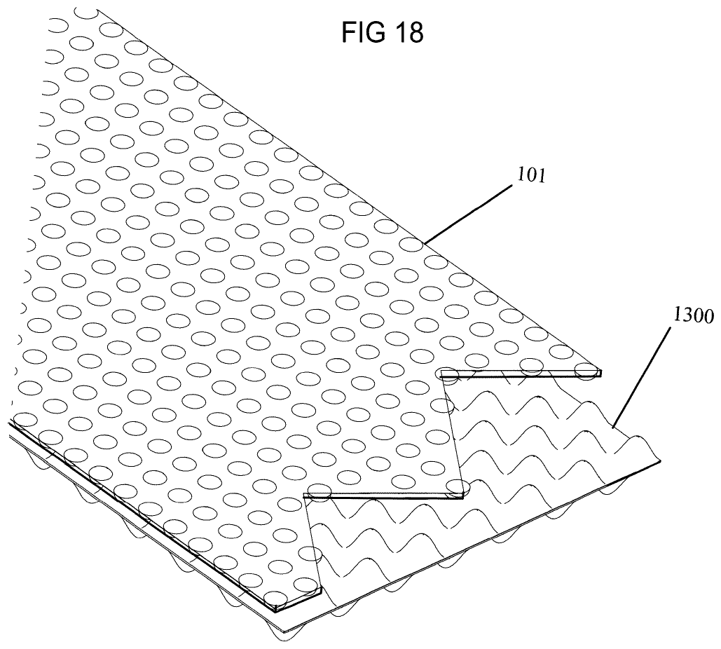

With respect to FIG. 18, FIG. 18 shows an embodiment that is generally similar to that shown in FIG. 16, but without the inner layer 104. In particular, the embodiment shown in FIG. 18 includes an outer layer 101 having an array of downwardly facing circular embossments and an intermediate paper layer 1300 that includes an undulating sheet of paper similar to that shown in FIG. 16. In some embodiments, an inner layer can be provided of any particular type as described in the present application. In some other embodiments, a similar combination of the outer layer 101 and intermediate layer 1300 shown in FIG. 18 can be placed facing upwardly beneath the layers shown in FIG. 18 to create a composite material according to some other embodiments that includes two intermediate undulating paper layers.

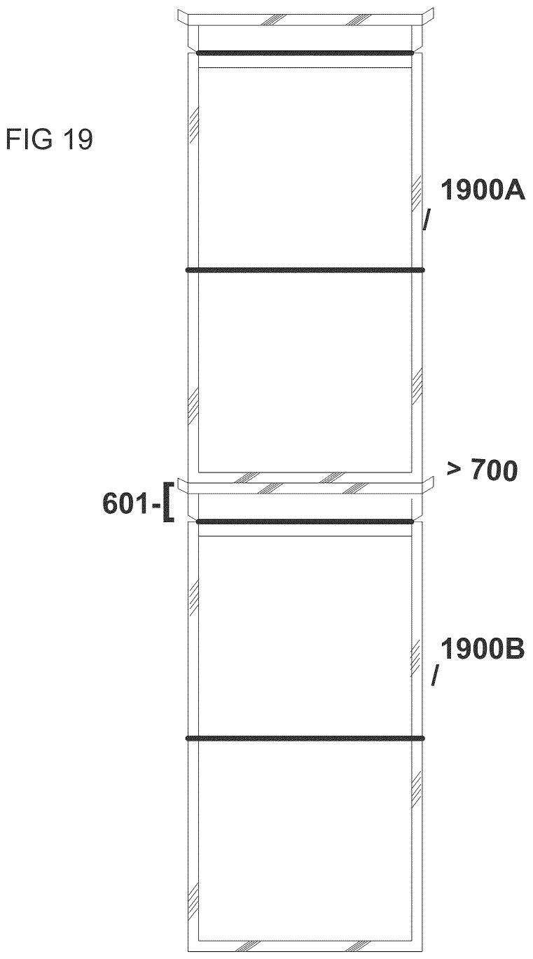

With reference to FIGS. 19-22, various exemplary methods and techniques for manufacturing envelopes according to various embodiments of the invention are depicted in these figures.

In some of the preferred embodiments, the envelopes are preferably manufactured by conveying rolls of material so as to create a composite of aligned layers that are conveyed parallel to and alongside one another, such as, for example, as shown in FIG. 3, in which the composite of aligned layers is shown at 302. The various embodiments described herein can all include conveying devices similar to that shown in FIG. 3 to convey an elongated composite of aligned layers, and, such layers can then be processed to create a plurality of envelopes, such as, e.g., by connecting together portions of the layers (such as, e.g., at edge regions 402, 203). In some preferred embodiments, a plurality of composite materials (similar to 400 shown in FIG. 4, for example) for forming envelopes are formed in an end-to-end relationship, such as, e.g., shown in FIG. 19. Then, after formation, the formed composite materials can be cut from the conveyed end-to-end conveyed materials, to as to form separated individual composite materials similar to 400 shown in FIG. 4, for example. Then, the composite materials can be folded over and glued to form enclosed envelopes, such as shown in FIGS. 5-6, for example.

As shown in FIG. 19, in the preferred embodiment, the conveyed composite of aligned layers includes a plurality of composite materials (corresponding to a plurality envelopes) connected together in an end-to-end manner. For example, FIG. 19 shows two composite material portions 1900A and 1900B connected together in a repeated pattern, wherein, the composite materials shown in FIG. 19 are configured such as to be used form envelopes of the type shown in FIG. 7.

As illustrated in FIG. 19, in this illustrated embodiment, the region 700 formed at the bottom end of composite material portion 1900A (which is later folded over to form an outer edge of the mouth of a pouch as shown in FIG. 7) is in a state in which it is connected to a distal end of a flap portion 601 of the composite material portion 1900B.

In this illustrated example, the portions 1900A and 1900B are also depicted with release liners 701 attached to the portions 1900A and 1900B. Although in some embodiments, adhesive 502 can be placed at region 705 and the release liner 701 can be placed over the adhesive prior to separation of portions 1900A and 1900B, in some alternative embodiments, such adhesive 502 and release liners 701 could be added to individual portions 1900A and 1900B after separation.

In some illustrative embodiments, the flap portion 601 is approximately 1.5″ long (i.e., in a lengthwise direction of the portions 1900A/B) and the edge region 700 is approximately 0.5″ long (i.e., in a lengthwise direction of the portions 1900A/B).

In some preferred embodiments, in order to a) adhere together layers of composite materials, b) crush the expanded slit sheet paper within the combined layers of composite materials (or to crush other cushioning papers, such as, e.g., pleated papers, embossed papers, or the like, that are within the combined layers of composite materials in some embodiments), and c) separate the composite material portions 1900A/B, various conveying rollers are employed.

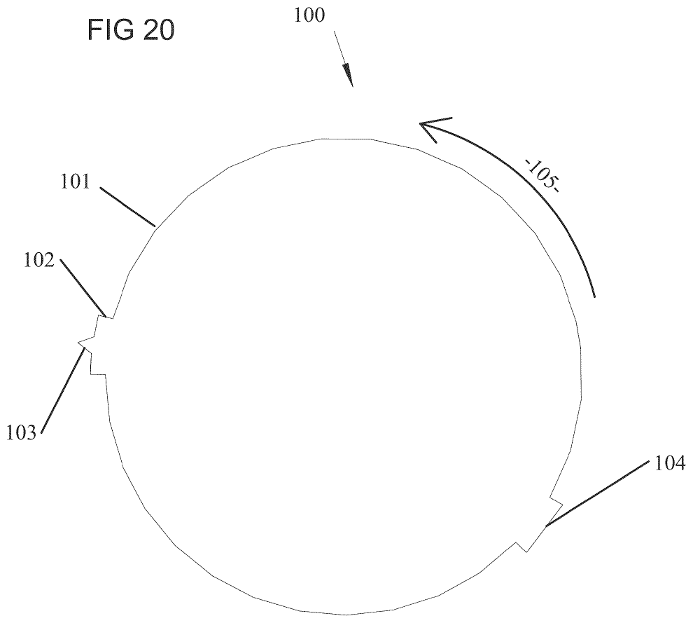

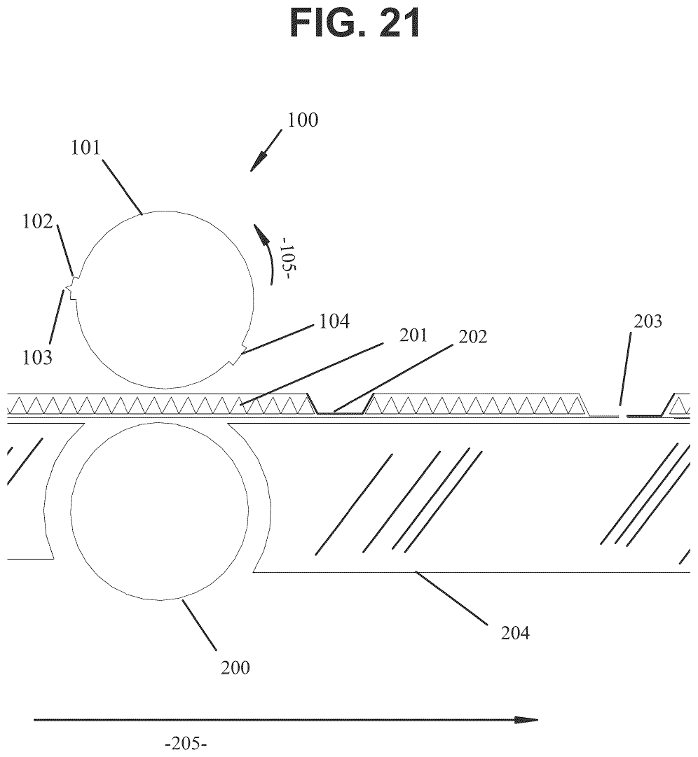

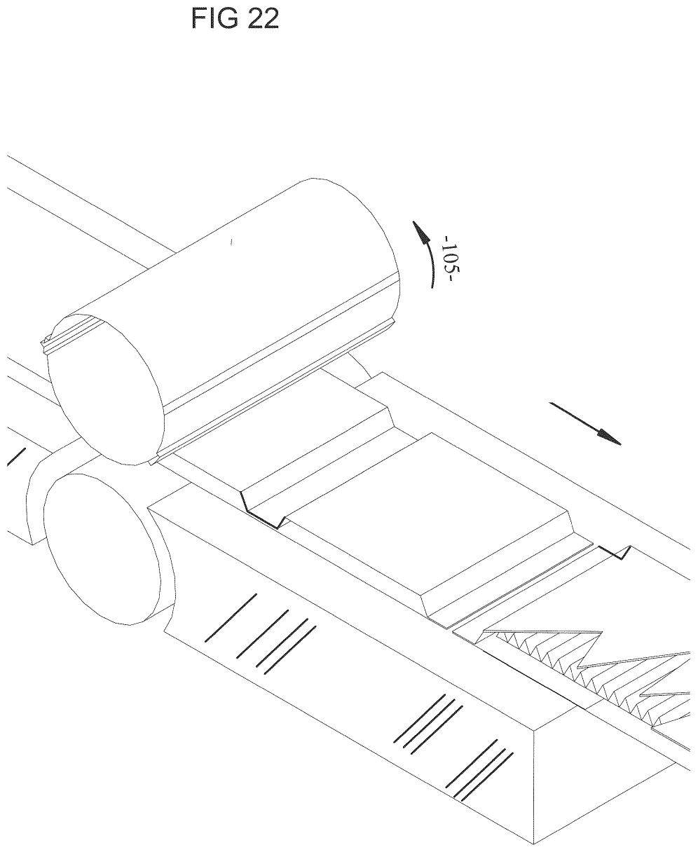

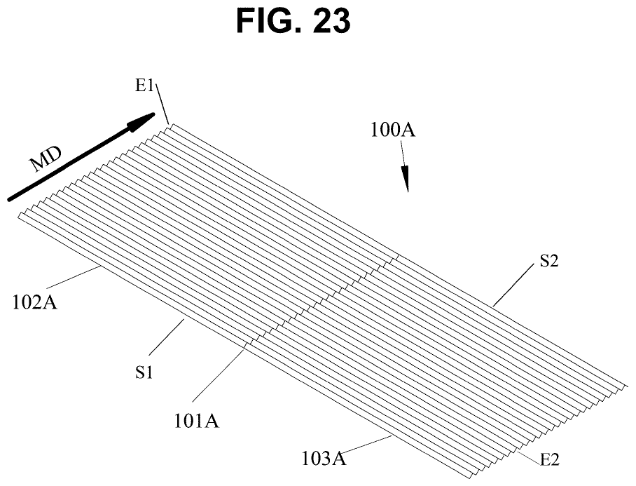

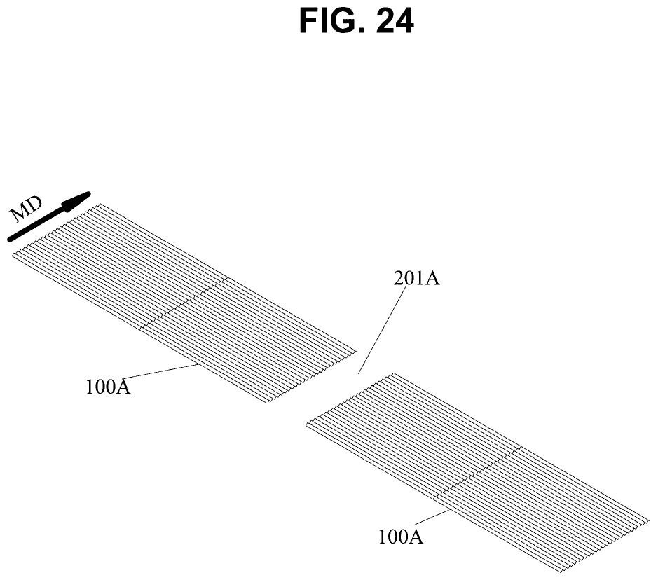

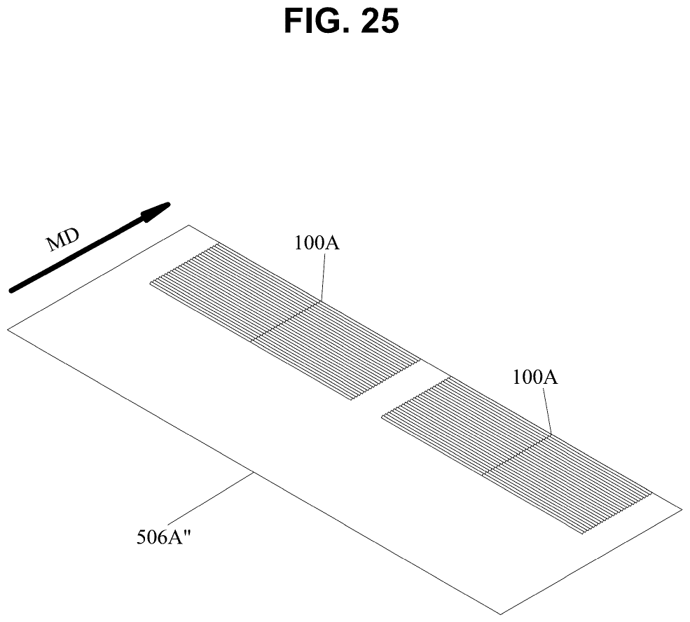

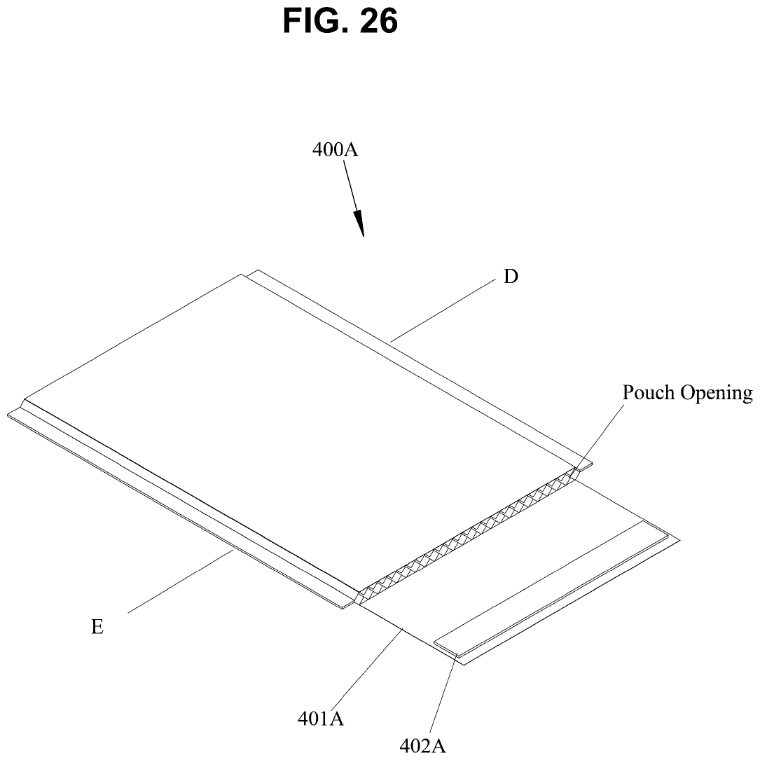

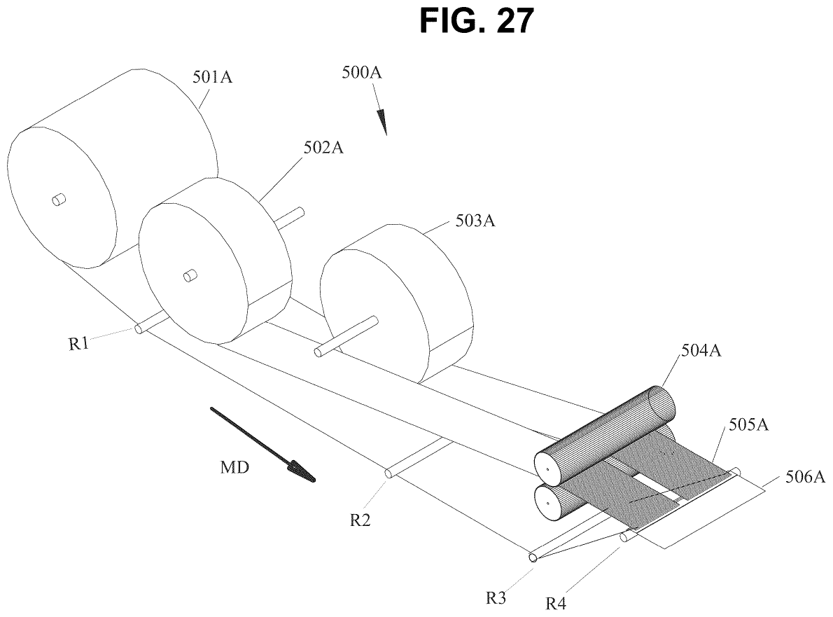

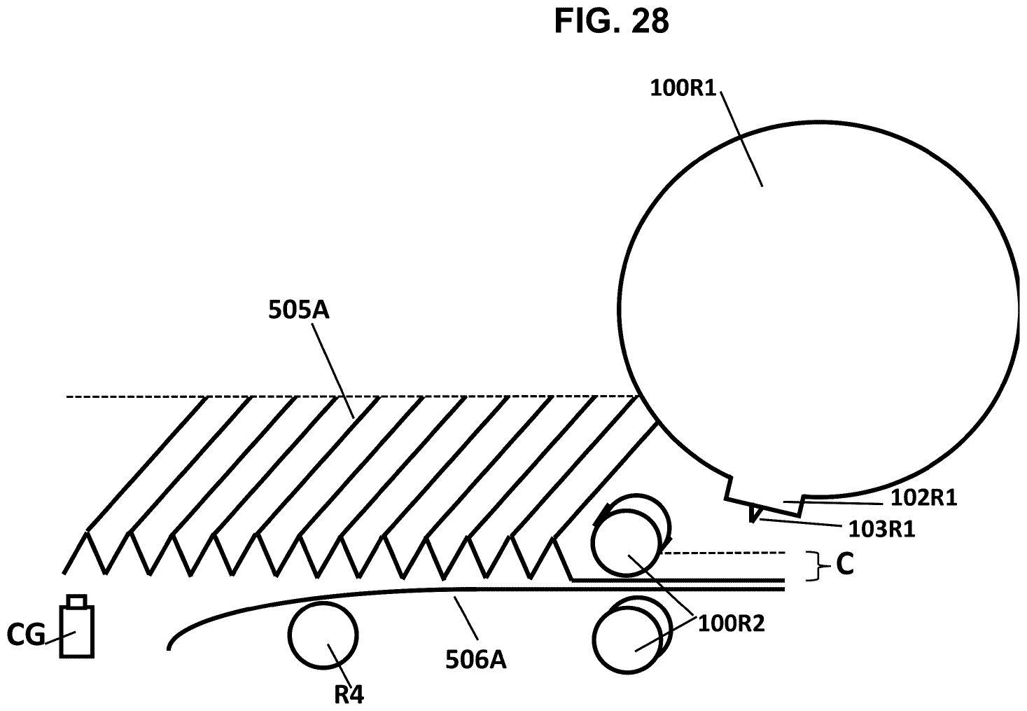

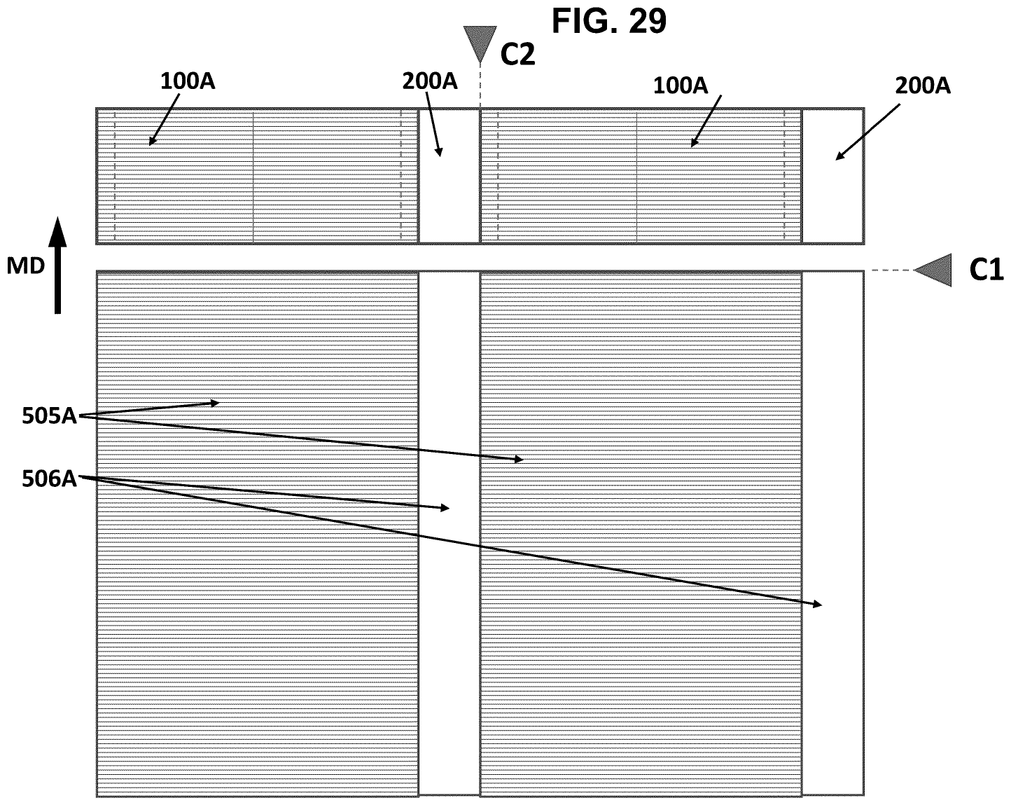

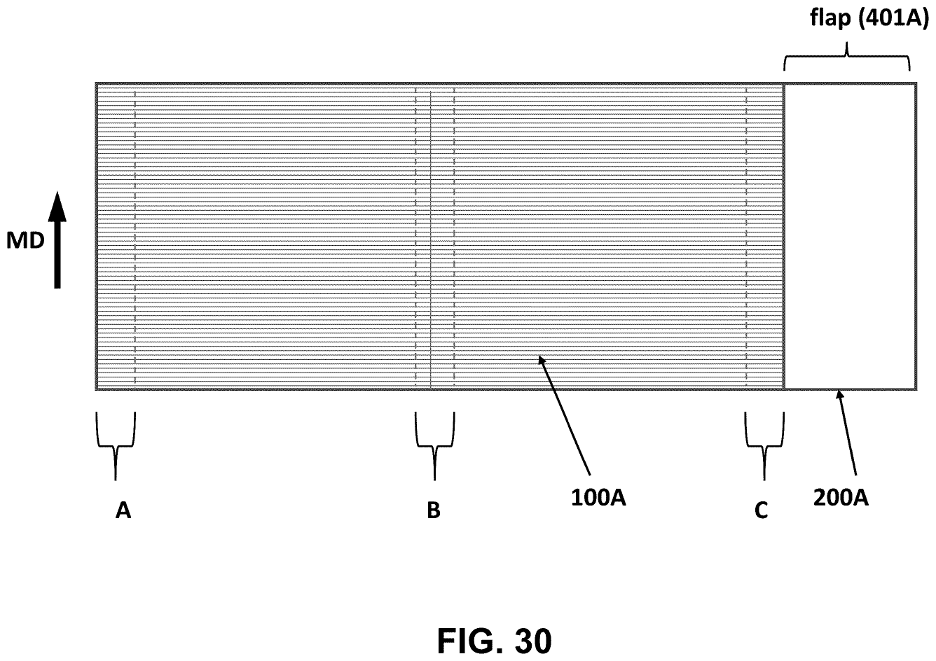

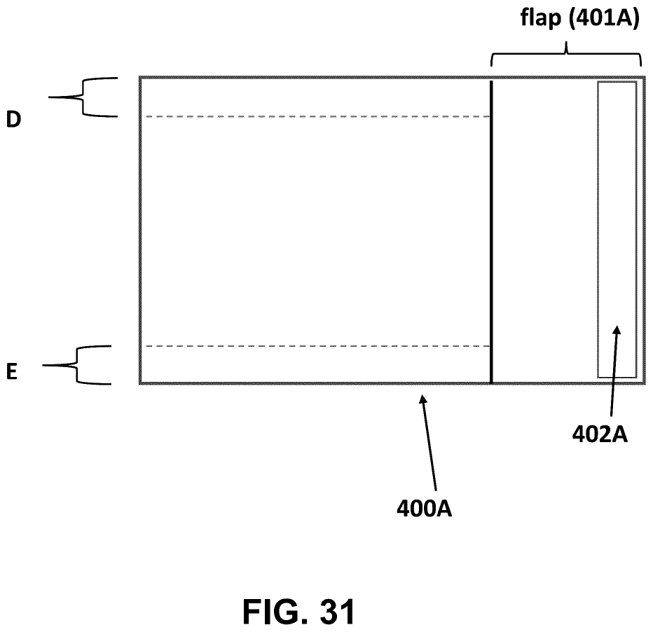

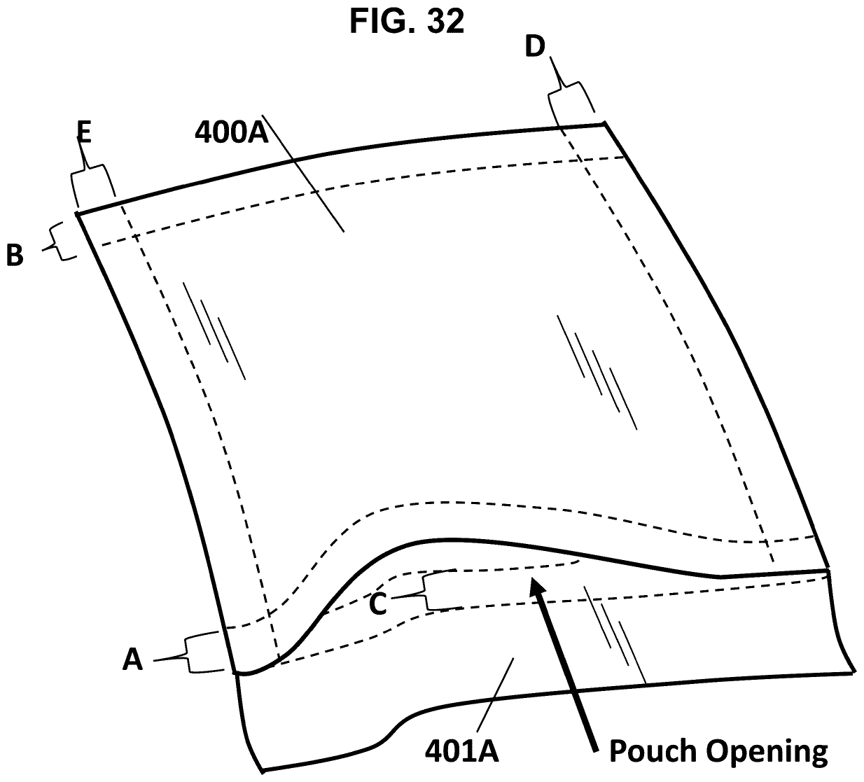

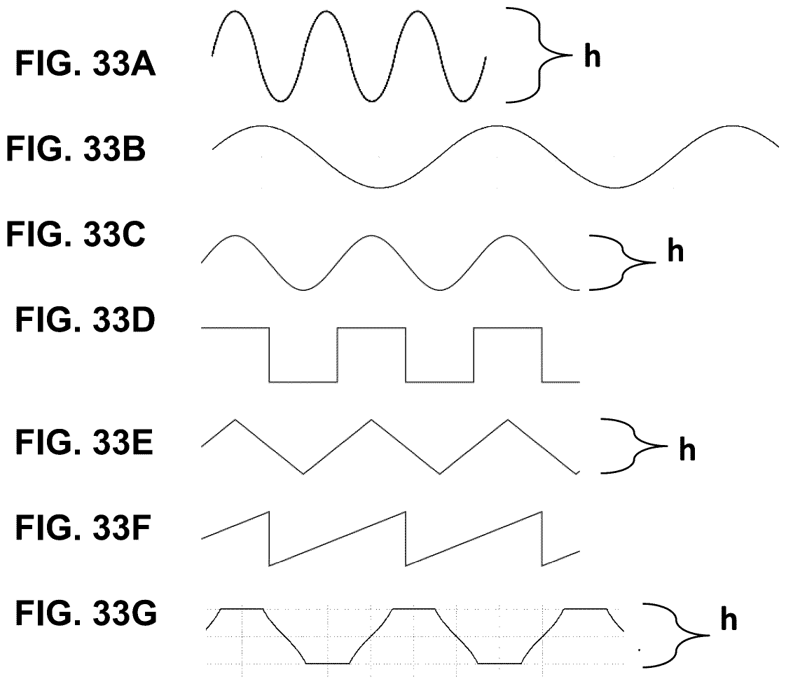

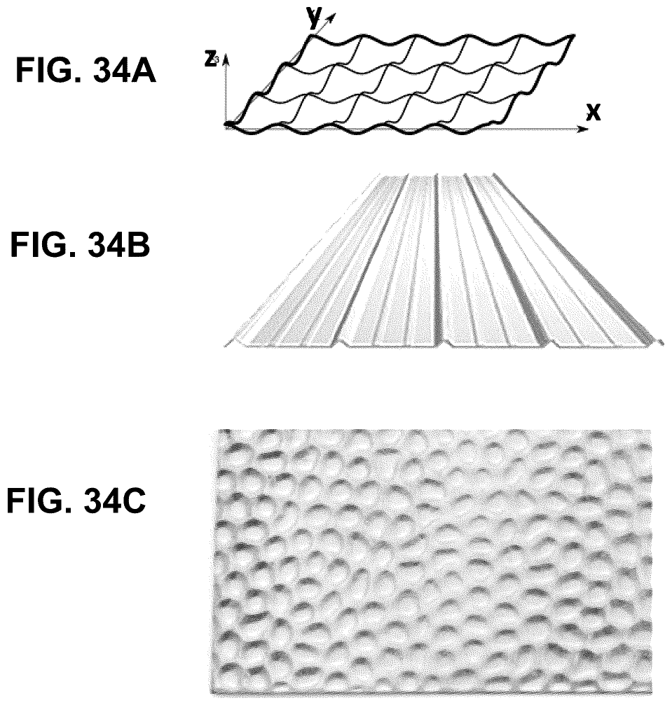

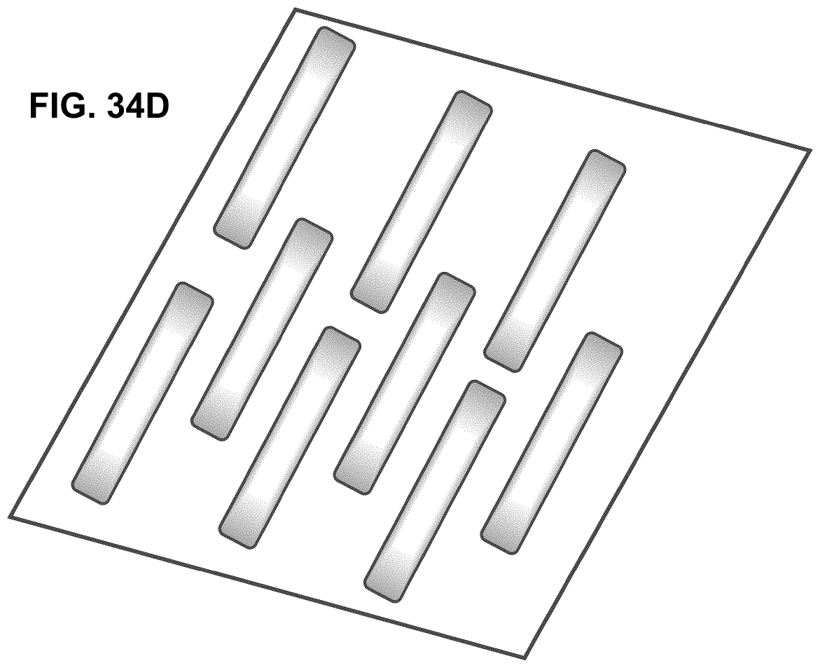

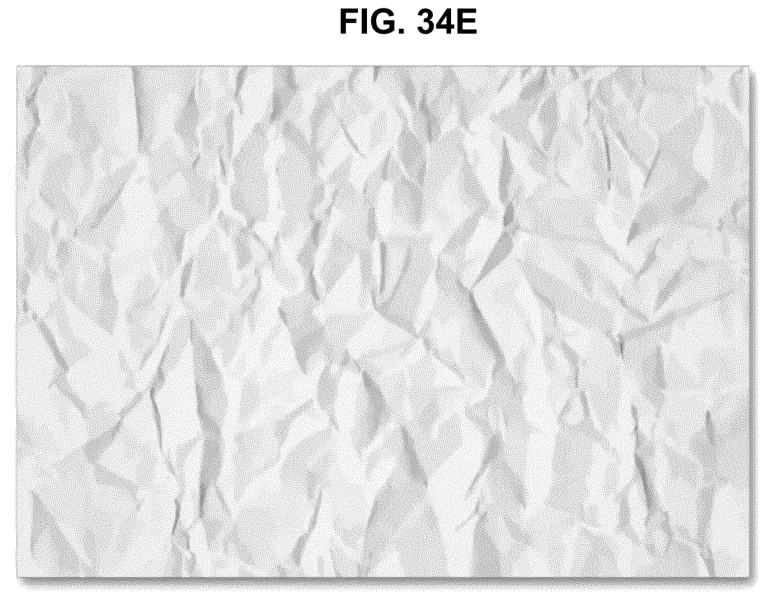

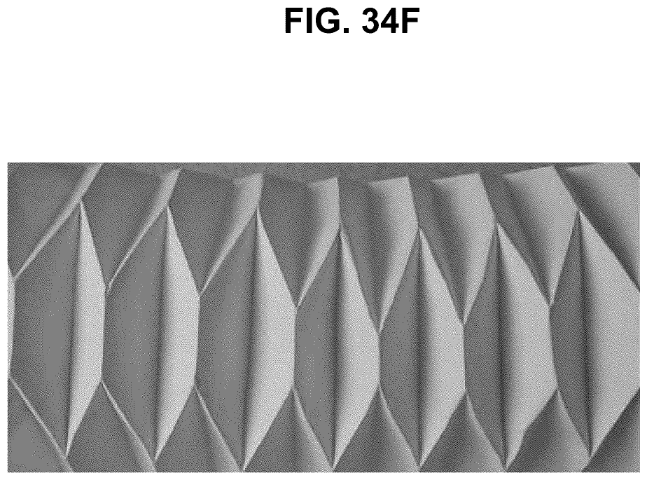

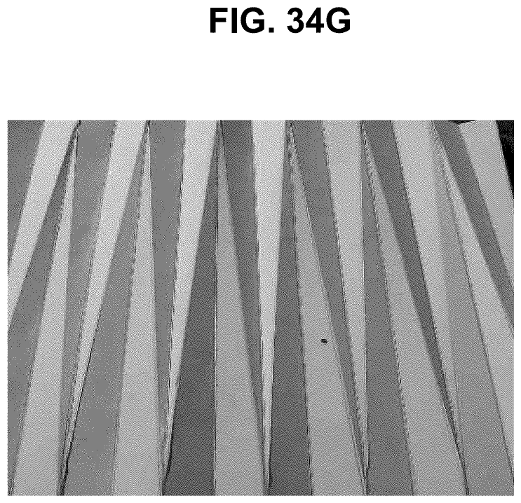

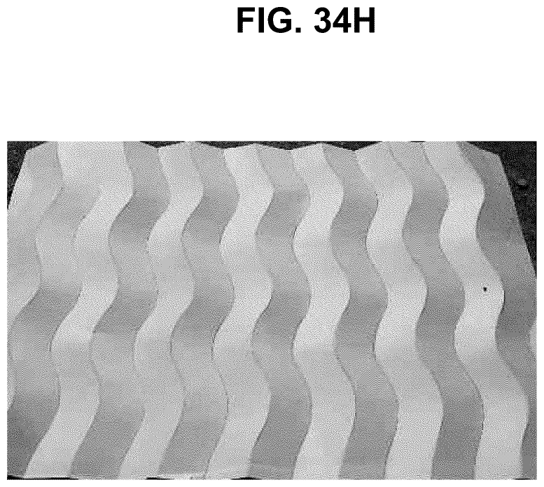

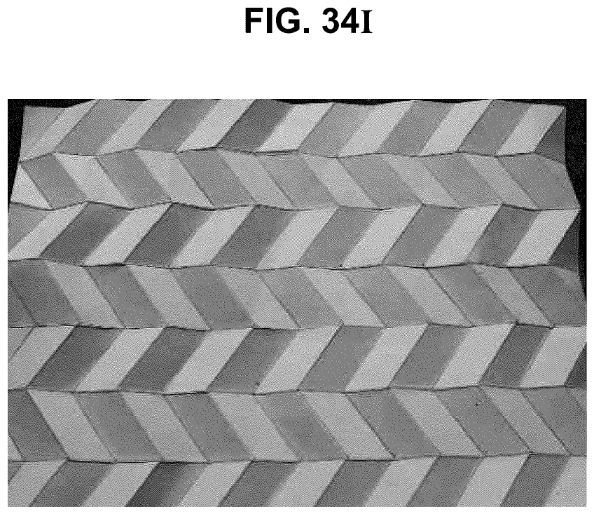

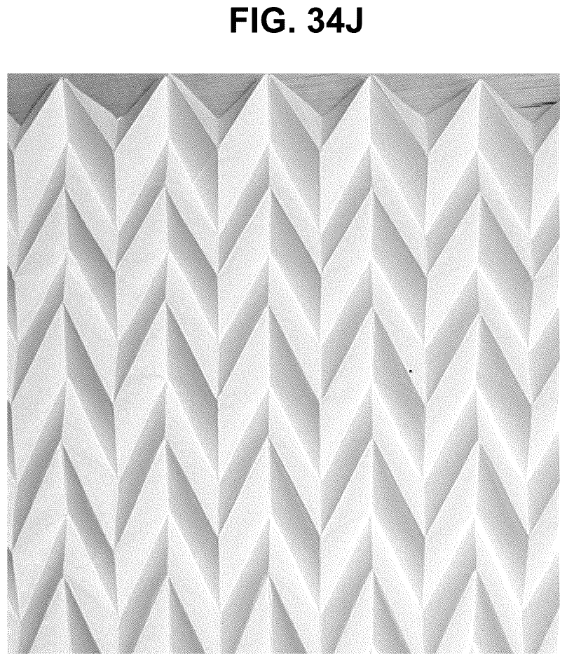

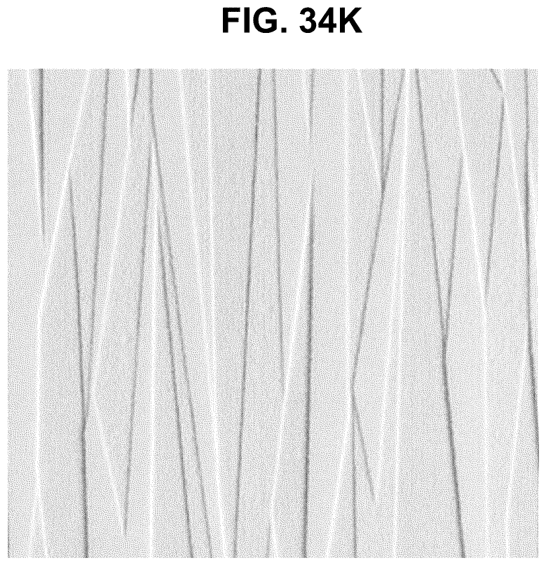

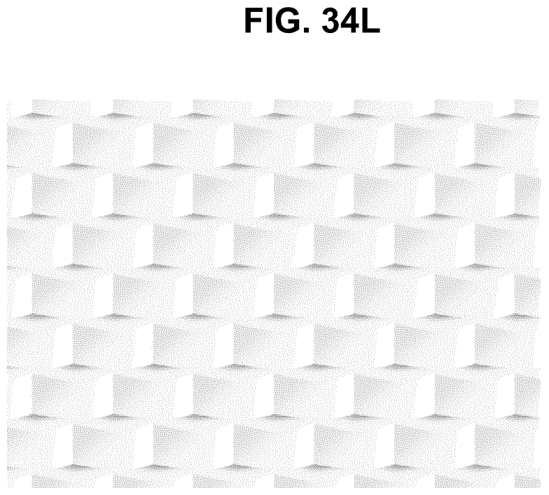

For example, FIG. 20 shows an illustrative conveying roller 100 that can be employed in some embodiments. In this illustrative example, the conveying roller is rotated in a direction counterclockwise as shown by the arrow 105 in FIG. 20. As shown in FIG. 21, the roller 100 cooperates with an opposing roller 200 and together rotate as the composite material layers are conveyed in the direction of the arrow 205 between the rollers 100/200 via the conveyor system. In the preferred embodiments, the roller 100 rotates in the direction of the arrow 105 at a same rate of the movement in the direction 205.

In the preferred embodiments, the roller 100 operates as a die cutting-crushing rotary tool where 101 is the outer circumference of the tool and is specifically sized to have a circumference that is the same as the total length of the envelope pad being made.

As shown in FIGS. 20 and 21, the roller 100 includes a depending pressure member 104 which is configured to cause the composite materials to become crushed in a region 202 as shown in FIG. 21 (e.g., by being pressed between the rolls 100 and 200 when the portion 104 is adjacent the roll 200). In addition, the roller 100 also includes a depending pressure member 102 that includes a cutting member 103 (e.g., a cutting blade or the like) which is configured to cause the composite materials to become crushed in a region 203 and also cut or separated in the region 203 (e.g., by being pressed between the rolls 100 and 200 when the portion 102 is adjacent the roll 200, and by being cut by the cutting member 103).

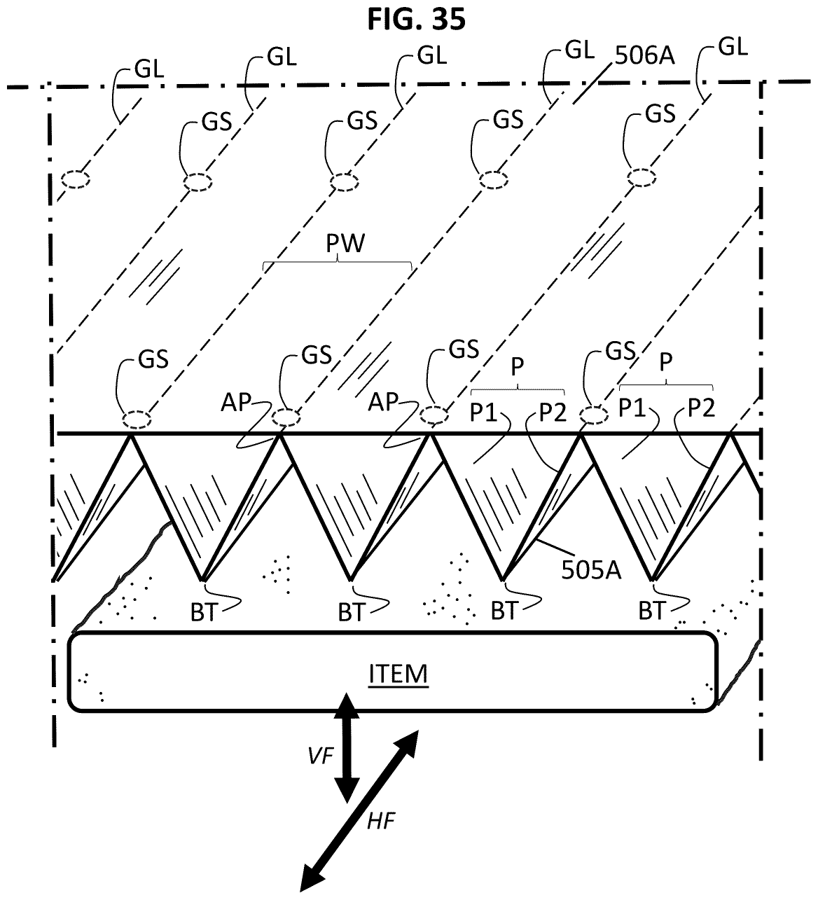

For reference, FIG. 22 shows a perspective view of the system shown in FIG. 21. Although FIGS. 21 and 22 schematically show at 201 an expanded paper that appears as a pleated paper, in the preferred embodiments, the element 201 is an expanded slit sheet paper in accordance with the most preferred embodiments of the invention. However, as should be appreciated based on this disclosure, in some less preferred embodiments, a pleated paper could be employed similar to the embodiment shown in FIG. 17 or any other cushioning layer described in other embodiments herein could be employed as an interior cushioning layer 201 of FIG. 21.

With reference to FIGS. 20-22, it is noted that these figures are schematic representations and some of the sizes or the like of the components are not to scale for the formation of some of the embodiments of the invention.

With reference to FIG. 21, in some preferred embodiments, the crushed region 202 which can be formed by the member 104 can be employed to create a narrow crushed region to facilitate folding to create an envelope pouch in some preferred embodiments. For example, this can be employed along the fold line 501 in the embodiment shown in FIG. 5 or to create a narrow crushed region at a location of the fold 709 shown in the embodiment of FIG. 7. In this manner, the composite material can be more readily folded over the fold line 501 or at the fold 709. Although FIG. 21 schematically shows a wide crushed portion, in some preferred embodiments, the width of the crushed region in a lengthwise direction (e.g., in the machine direction) is preferably less than ½ inch, or, in some embodiments, less than ⅓ inch, or, in some embodiments, less than ¼ inch, or, in some embodiments about ⅛ inch or even less.

In some preferred embodiments, prior to reaching the rollers 100 and 200, the composite materials pass a device that applies glue at regions to be glued during pressing of the rollers 100 and 200. For example, prior to pressing to create the crushed region 202, in the preferred embodiments, a narrow strip of glue is already applied by the glue device. In the preferred embodiments, the narrow strip of glue has a width in the length direction that is the same or less than the width of the crushed region in the lengthwise direction as discussed above.

With reference to FIG. 21, in some embodiments the region 203 represents a region in between adjacent portions for creating separate envelopes, such as, e.g., between adjacent portions 1900A and 1900B shown in the embodiment of FIG. 19. In addition, the crushed portion shown to the right of the cut in the region 203 in FIG. 21 (which cut having been made by the cutter) can correspond to, e.g., the portion 700 in the embodiment shown in FIG. 19 (as one illustrative example), while the crushed portion shown to the left of the cut in the region 203 in FIG. 21 can correspond to, e.g., the flap portion 601 shown in FIG. 19 (as one illustrative example).

As such, it should be appreciated that in some illustrative embodiments, the rollers 100 and 200 can be used to join together the layers by forming widthwise crushed and glued portions and separating the joined composite material portions for forming of individual separate envelopes.

Although not illustrated in FIGS. 20-22, in the preferred embodiments, after the layers are conveyed into the combining area 302 shown in FIG. 3 and before the layers are conveyed to the rollers 100 and 200, the composite layers are preferably directed to a glue device that applies glue to appropriate locations in between the composite layers at appropriate locations along the layers. In some embodiments, the glue device includes one or more glue dispensing nozzles that are computer controlled to dispense glue at precise locations between the layers. In some examples, the glue device can, for example, apply glue to one layer, such as, e.g., a bottom layer at a location in between the composite layers. Then, later, upon application of pressure (such as, e.g., between the rollers 100 and 200) the applied glue can permeate and adhere between all of the layers in some embodiments.

Additionally, although also not shown in the figures, concurrently with application of the glue by the glue device or after application of the glue but prior to conveyance to the rollers 100 and 200, in some preferred embodiments, the lateral side edges of the composite layers are preferably adhered together by applying pressure rollers along both lateral side edges of the composite layers, such as to form, for example, connected regions 402 shown in the illustrative example of FIG. 4. In order to adhere the lateral side edges, it should be appreciated that the glue device should also preferably apply glue at appropriate lateral side edges to enable formation of the edge regions 402 or the like.

In this manner, prior to connecting together of the composite layers cross-wise across a width of the layers (i.e., transverse to the machine direction), the composite layers are preferably initially attached along their lateral edges to form a generally tubular configuration prior to passing between the rollers 100 and 200.

In the schematic representations shown in FIGS. 21 and 22, the lateral side edges of the composite layers are not illustrated as adhered together. However, in the preferred embodiments, as discussed above, the lateral side edges are adhered prior to passing through the rollers 100 and 200.

Although FIG. 19 shows notch regions already formed along the flap region 601, in the preferred embodiments, notch regions (such as, e.g., notches 706 shown in FIG. 7) are concurrently formed by the rollers 100 and 200, in such a manner that in addition to incorporating a cutting element 103 to separate adjacent portions, the roller 100 can include additional cutting elements to form similar notches 706.

Additionally, although not depicted in FIGS. 20-22, in addition to a cutting element 103 the member 102 can also include a pressing element that does not cut through the composite material, but that creates a score line extending between the notches 706 in order to facilitate tearing for opening of the pouch after being sealed closed.

Accordingly, in the illustrated embodiments, attached to the outer circumference of the roller 100 is crush area member 102 in combination with cutting element 103 and score line crushing area member 104 that creates a fold region for the pouch area of the envelope as the roller 100 rotates in direction of arrow 105. The die cutting-crushing areas 102 and 103 make contact with the envelope pad layers are which are crushed and cut at 203. Continuing the rotation crush only area 104 had just crushed in area 202 and the repeat of the crushing would make an additional crush cut 203 to continuously make envelope pads.

Additional Noteworthy Aspects of Some Preferred Embodiments (Related to Ser. No. 16/870,195)

As discussed herein-above, in the preferred embodiments, an embossed paper is employed which provides a flexibility and a slight cushioning protection not found in flat sheet paper.

In some preferred embodiments, the expanded slit material is not adhered to the sides (e.g., not adhered to regions 402 shown in FIG. 4, regions 705 shown in FIG. 7, etc.), but, advantageously, only or substantially only to the front and back areas. Among other things, this advantageously provides for much smaller use of adhesive and produces a superior and much more sustainable padded envelope.

In some preferred embodiments, the present invention employs expanded slit sheet material in combination with top and bottom exterior layers of paper to produce a padded envelope with cushioning properties. To provide this on a continuous basis with consistent optimal stretching of the slit sheet material a rotary method of die cutting and crushing is preferred.

In some preferred embodiments, a padded envelope is provided in which the mouth opening of the padded envelope is across the width of the machine. On the other hand, in existing systems, manufacture a mouth is transverse to the direction of the preferred embodiments herein. In existing systems for making envelopes, there is no concern to deal with a simultaneous stretching of a slit paper (since such paper has not previously been employed), and, therefore, existing systems orient envelopes such that more envelopes can be made per minute. In addition, for existing systems, laminating is done with heat for plastic bubble and, therefore, is instantaneous unlike the requirement for drying of a paper cold glue or a cooling of a paper hot melt glue. It is typical that the length of the envelope is wider that the mouth or envelope width. By way of example, if the bubble padded envelope is 10″ wide by 20″ long then, each guillotine cut happens every 10″ versus every 20″ and therefore doubles the padded envelope making speed.

An issue with a guillotine making system is that it separates the leading envelope from the prior envelope and places a higher burden on maintaining the stretch of the slit sheet material in a smaller number of glued square inch area of the immediate envelope.

During the manufacturing process where the glue is in the process of drying and/or cooling, it is, therefore, more vulnerable from distortion and delamination from the retracting slit sheet material. To overcome this, the rotary method is the best way to maintain the maximum amount of paper adhesive combination. If the instant process used a guillotine, then the web would slacken during the cutting process, thus, producing wrinkling and delamination.

There is an additional reason for the rotary method required for slit sheet material. The expanded slit sheet is most conveniently stretched in the direction of manufacture. Since most padded envelopes are longer than they are wide, manufacturing in the width direction would cause either one of two scenarios:

The first, is the expanding the slit sheet in the direction of manufacture and would in many instances require multiple webs of material being stretched which, would require more than one slit sheet die cutter and the handling and exact position of the multiple side-by-side webs required. The maximum available width of a die cutting machine is 30″ which makes the stretched width of 23.5″. The envelope still requires folding for the pouch and the fold over seal of about 1.5″ making the usable pouch area 11″. Many envelopes are longer that 11″ for the pouch area. Again, the solution would be multiple die cutters to manage the full length required and the complications of placing them side by side.

The second is by expanding in the transverse direction of manufacture which would require one web but, would require a holding mechanism to maintain stretch while gluing the multiple layers in a step-by-step basis rather than a continuous manufacturing process.

Either approach creates a further issue of cost of machinery. On the other hand, the present machine is small in footprint and can be placed close to markets that would be too small for width direction equipment.

In some preferred embodiments, in order to be able to adhere a label to an outer surface (such as, e.g., a shipping label), an envelope outer layer is embossed very lightly, and preferably with narrow embossments, and with embossments that do not protrude outwardly. And, at the same time, an envelope inner layer can preferably be embossed more heavily (e.g., on an inside surface of the envelope).

Customers often consider the weight of the envelope to be an important aspect as, e.g., customers desire to save money on postage. Paper having outer layer—expanded layer—inner layer weights that are each below, e.g., 50 pounds or each below 45 pounds, or, e.g., about 43-43-43 pounds, or, e.g., about 40-40-40 pounds as envelope weights, can employ aspects of preferred embodiments described herein and employ embossing (e.g., an inner embossing) along with an extensible slit sheet paper to avoid wrinkling. The use of an inner embossing allows items to be loaded easily and adds more resilience.

In some preferred embodiments, paper cushioning alternatives and/or expanded slit sheets are sealed to at least one of the inner or outer layers of indented paper, Kraft/rip proof, standard Kraft, or other non-slit sheet material. The sealing can be at or proximate to the end regions 403 as shown in FIG. 4 or can be at or proximate to side regions 402 as shown in FIG. 4, or to both side and end regions. While the sealing can be to one side region and one end region, preferably, the sealing is to opposing side and/or end regions.

While some of the examples relate to the use of two layers of expanded slit sheets, in some preferred embodiments, a single layer preferably can be used. Further, in some embodiments, even more than two layers of expanded slit sheets can be employed. Thus, at least one layer is employed in the envelope and multiple layers can be employed, as for example, two layers, three layers, four layers, or greater than four layers where enhanced cushioning is desired.

In some preferred embodiments, the latter numbers of layers of expanded slit sheets refer to numbers of layers of expanded paper between the inner most and outer most layers. Accordingly, when the structure as illustrated in embodiments described above are doubled over, the total number of layers of expanded slit sheets in the envelope is doubled while the number of layers of expanded slit sheet layers between the inner most layer and outer most layer is unchanged.

In the most preferred embodiments, the various envelopes of the embodiments of the present invention can be recycled by consumers along with newspapers, magazines, and corrugated containers, etc. There are three categories of paper that can be used as feedstocks for making recycled paper: mill broke, pre-consumer waste, and post-consumer waste. Mill broke is paper trimmings and other paper scrap from the manufacture of paper, and is recycled in a paper mill. Pre-consumer waste is a material which left the paper mill but was discarded before it was ready for consumer use. Post-consumer waste is material discarded after consumer use, such as old corrugated containers (OCC), old magazines, and newspapers. Paper suitable for recycling is called “scrap paper,” often used to produce molded pulp packaging.

By way of contrast, air bubble wrapping sheets and Tyvek® envelopes can be recycled, but it should not be added to a consumer's recycling container. Instead, bubble wrap, Tyvek, and plastic bags should be recycled at special collection points. This guidance applies not only to bubble wrap, but also to completely plastic bubble mailers and to air pillows. Air bubble mailers with paper outsides, however, cannot be recycled as-is. If it is feasible to disassemble them into their separate material parts, one could then recycle the paper along with other paper recyclables, and then take the bubble wrap to a drop-off location along with other plastic films. Information about recycling of plastics can be found at “How2Recycle”: http://www.how2recycle.info/sdo

### Illustrative Examples of Embodiments of the Invention (Related to 16/870,195)

### Example A

Envelope for use within a container:
layer 1 is indented;
layer 2 is expanded slit sheet (uniformly opening);
layer 3 is expanded slit sheet, (uniformly opening) crossed-pattern with respect to layer 2;
layer 4 is indented.

### Example B

Envelope for use within a container:
layer 1 is Kraft paper;
layer 2 is expanded randomly opening slit sheet;
layer 3 is expanded randomly opening slitsheet;
layer 4 is Kraft paper

### Example C

Mailing envelope for mailing via UPS, FedEx, USPS, etc.:
layer 1 (outer layer) is Kraft/rip proof;
layer 2 is expanded uniformly opening slit sheet;
layer 3 is expanded uniformly opening slit sheet, and crossed-patterned with respect to layer 2;
layer 4 is indented.

### Example D

Mailing envelope for mailing via UPS, FedEx, USPS, etc.:
layer 1 (outer layer) is Kraft/rip proof,
layer 2 is expanded randomly opening slit sheet;
layer 3 is expanded randomly opening slit sheet;
layer 4 is indented.

### Example E

Mailing envelope for mailing via UPS, FedEx, USPS, etc.:

layer 1 (outer layer) is Indented;
layer 2 is expanded randomly opening slit sheet;
layer 3 is expanded randomly opening slit sheet layer 4 is indented.

### Example F

Mailing envelope for mailing via UPS, FedEx, USPS, etc.:
layer 1 (outer layer) is 50# Kraft;
layer 2 is expanded randomly opening slit sheet;
layer 3 is expanded randomly opening slit sheet layer 4 is a 30# Kraft.

### Example G

Mailing envelope for mailing via UPS, FedEx, USPS, etc.:

layer 1 (outer layer) is Indented;
layer 2 is expanded randomly opening slit sheet;
layer 3 is expanded randomly opening slit sheet;
layer 4 is a 30# Kraft.

### Example H

Mailing envelope for mailing via UPS, FedEx, USPS, etc.;
layer 1 (outer layer) is downward facing indented;
layer 2 is double facing indented.”

### SUMMARY OF THE INVENTION

The preferred embodiments overcome shortcomings in the background art.

According to a first Example 1, a protective product is provided that comprises:
an envelope having a two-layer wall structure,
the two-layer wall structure including:
a) a first outer paper layer, and
b) a second inner paper layer,
wherein the second inner paper layer:
i) includes width-wise positional variations of the side surface of the second inner paper layer that cushions items placed within an inner pouch of the envelope, and
ii) forms an interior wall of the inner pouch of the envelope and directly contacts the items placed within the inner pouch of the envelope,

According to a further Example 2, the protective product of Example 1 further includes that said first outer paper layer and said second inner paper layer are folded together to form a pouch, with said second inner paper layer forming the interior wall of said pouch that directly contacts items placed within said pouch during use and with said first outer paper layer forming an outside wall of said pouch at an exterior of the envelope.

According to a further Example 3, the protective product of Example 1 or any of the other preceding Examples, further includes that said width-wise positional variations of the side surface of the second inner paper layer includes pleats, undulations and/or embossments.

According to a further Example 4, the protective product of Example 1 or any of the other preceding Examples, further includes that said pleats, undulations and/or embossments include ridges that extend perpendicular or substantially perpendicular to an outlet of the envelope.

According to a further Example 5, the protective product of Example 4 further includes that said ridges extend a distance of greater than 30% of the depth of the envelope from the opening to a bottom of the pouch of the envelope, or, in some preferred embodiments, wherein said ridges extend a distance of greater than 40% of the depth of the envelope from the opening to a bottom of the pouch of the envelope, or, in some preferred embodiments, wherein said ridges extend a distance of greater than 50% of the depth of the envelope from the opening to a bottom of the pouch of the envelope, or, in some preferred embodiments, wherein said ridges extend a distance of greater than 60% of the depth of the envelope from the opening to a bottom of the pouch of the envelope, or, in some preferred embodiments, wherein said ridges extend a distance of greater than 70% of the depth of the envelope from the opening to a bottom of the pouch of the envelope, or, in some preferred embodiments, wherein said ridges extend a distance of greater than 80% of the depth of the envelope from the opening to a bottom of the pouch of the envelope, or, in some preferred embodiments, wherein said ridges extend a distance of greater than 90% of the depth of the envelope from the opening to a bottom of the pouch of the envelope, or, in some preferred embodiments, wherein said ridges extend a distance of greater than 95% of the depth of the envelope from the opening to a bottom of the pouch of the envelope.

According to a further Example 6, the protective product of Example 1 or any of the other preceding Examples, further includes that said width-wise positional variations of the side surface of the second inner paper layer includes peaks adjacent said first outer paper layer, and wherein adhesive is applied between said peaks and said first outer paper layer that adheres said second inner paper layer to said first outer paper layer.

According to a further Example 7, the protective product of Example 1 or any of the other preceding Examples, further includes that said width-wise positional variations of the side surface of the second inner paper layer includes peaks adjacent said first outer paper layer, wherein said peaks extend substantially perpendicular to an opening into a pouch of said envelope.

According to a further Example 8, the protective product of Example 1 or any of the other preceding Examples, further includes that said first outer paper sheet is an unembossed paper sheet.

According to a further Example 9, the protective product of Example 1 or any of the other preceding Examples, further includes that first outer paper sheet is an embossed paper sheet.

According to a further Example 10, the protective product of Example 1 or any of the other preceding Examples, further includes that said first outer paper sheet is a substantially flat paper sheet.

According to a further Example 11, the protective product of Example 1 or any of the other preceding Examples, further includes that said first outer paper sheet is a Kraft paper sheet.

According to a further Example 12, the protective product of Example 1 or any of the other preceding Examples, further includes that said first outer paper sheet is a Kraft paper sheet having a weight of 30# or more under the TAPPI standard paper weight specification for 3000 square feet.

According to a further Example 13, the protective product of Example 1 or any of the other preceding Examples, further includes that said first outer paper sheet is a Kraft paper sheet having a weight of 40# or more under the TAPPI standard paper weight specification for 3000 square feet.

According to a further Example 14, the protective product of Example 1 or any of the other preceding Examples, further includes that said first outer paper sheet is a Kraft paper sheet having a weight of 50# or more under the TAPPI standard paper weight specification for 3000 square feet.

According to a further Example 15, the protective product of Example 1 or any of the other preceding Examples, further includes that said first outer paper sheet is a Kraft paper sheet having a weight of 60# or more under the TAPPI standard paper weight specification for 3000 square feet.

According to a further Example 16, the protective product of Example 1 or any of the other preceding Examples, further includes that said first outer paper sheet is a Kraft paper sheet having a weight of 30# or more under the TAPPI standard paper weight specification for 3000 square feet, or, in some examples, 40# or more under the TAPPI standard paper weight specification for 3000 square feet, or, in some examples, 50# or more under the TAPPI standard paper weight specification for 3000 square feet, or, in some examples, 60# or more under the TAPPI standard paper weight specification for 3000 square feet.

According to a further Example 17, the protective product of Example 1 or any of the other preceding Examples, further includes that the first outer paper sheet is adhered to the second inner paper sheet.

According to a further Example 18, the protective product of Example 1 or any of the other preceding Examples, further includes that the first outer paper sheet is adhered to the second inner paper sheet with cold glue.

According to a further Example 19, a method is provided including: providing the protective product of Example 1 or any of the preceding Examples; and placing an item within a pouch of said protective product.

According to a further Example 20, a method of making the protective product comprising an envelope having a two-layer wall structure, the two-layer wall structure including a) a first outer paper layer, and b) a second inner paper layer, wherein the second inner paper layer includes width-wise positional variations of the side surface of the second inner paper layer that cushions items placed within an inner pouch of the envelope, and forms an interior wall of the inner pouch of the envelope and directly contacts the items placed within the inner pouch of the envelope, comprising the steps of:
a) conveying the first outer paper layer in a machine direction;
b) conveying the second inner paper layer in the machine direction alongside said first outer paper layer;
c) creating width-wise positional variations of the side surface of the second inner paper layer for cushioning items placed within an inner pouch of the envelope, said width-wise positional variations including ridges that extend transverse to the machine direction;
d) adhering the first outer paper layer to the second inner paper layer;
e) cutting a composite section of the first outer paper layer and the second inner paper layer for forming at least one individual envelope by severing the first outer paper layer and the second inner paper layer across a width thereof transverse to the machine direction; and
f) folding the composite section of the first outer paper layer and the second inner paper layer around a fold line parallel to the machine direction to create the inner pouch and such that the second inner paper layer forms the interior wall of the inner pouch of the envelope and directly contacts the items placed within the inner pouch, and wherein said ridges extend within said pouch substantially transverse to the opening of the pouch.

According to a further Example 21, the method of Example 20 further includes that said adhering includes cold gluing the first outer paper layer to the second inner paper layer.

According to a further Example 22, an envelope is provided that comprises: a composite of a) a first outer sheet of paper; and b) a second inner sheet of paper configured to provide cushioning, wherein the second inner sheet of paper forms an interior wall of the inner pouch of the envelope without an inner layer, the second inner sheet of paper being configured to provide cushioning and directly contacting items placed within the inner pouch of the envelope.

According to a further Example 23, the envelope of Example 22 further includes that the first outer sheet of paper includes a sheet of paper having no embossments.

According to a further Example 24, the envelope of Example 22 or 23 further includes that the first outer sheet of paper comprises a sheet of Kraft paper, or, in some embodiments, wherein the first outer sheet of paper is a Kaft sheet having a weight of paper or more under the TAPPI standard paper weight specification for 3000 square feet, or, in some embodiments, wherein the first outer sheet of paper is a Kaft sheet having a weight of 40# paper or more under the TAPPI standard paper weight specification for 3000 square feet, or, in some embodiments, wherein the first outer sheet of paper is a Kaft sheet having a weight of 50# paper or more under the TAPPI standard paper weight specification for 3000 square feet, or, in some embodiments, wherein the first outer sheet of paper is a Kaft sheet having a weight of 60# paper or more under the TAPPI standard paper weight specification for 3000 square feet.

According to a further Example 25, the envelope of Examples 22-24 further include that the first outer sheet of paper is sufficiently strong to inhibit inadvertent tearing of the envelope during use, such as, e.g., during shipping and/or mailing.

According to a further Example 26, the envelope of Examples 22-24 further include that the first outer sheet of paper includes embossments.

According to a further Example 27, the envelope of any of the preceding Examples further includes that the second inner sheet of paper is configured to provide cushioning by providing width-wise positional variations of the side surface of the second inner sheet.

According to a further Example 28, the envelope of any of the preceding Examples further includes that the width-wise positional variations of the side surface of the second inner sheet include pleats.

According to a further Example 29, the envelope of any of the preceding Examples further includes that the width-wise positional variations of the side surface of the second inner sheet include undulations.

According to a further Example 30, the envelope of any of the preceding Examples further includes that the width-wise positional variations of the side surface of the second inner sheet include embossments.

According to a further Example 31, the envelope of any of the preceding Examples further includes that the width-wise positional variations of the side surface of the second inner sheet include embossments extending in a direction away from an interior of the pouch.

According to a further Example 32, the envelope of any of the preceding Examples further includes that the width-wise positional variations of the side surface of the second inner sheet include embossments extending only in a direction away from an interior of the pouch.

According to a further Example 33, the envelope of any of the preceding Examples further includes that the width-wise positional variations of the side surface of the second inner sheet include embossments extending both in a direction away from an interior of the pouch and extending in a direction toward the interior of the pouch.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF DRAWINGS

A number of preferred embodiments of the invention are shown by way of example, and not limitation, in the accompanying figures, in which:

a) FIGS. 1-22 are figures from parent application Ser. No. 16/870,195, wherein:

FIG. 1 is a side view of the composite material of expanded slit sheets enveloped in indented Kraft sheets;

FIG. 2 is a perspective view of the composite material of expanded slit sheets enveloped in indented Kraft sheets;

FIG. 3 is a schematic side view of the manufacturing process;

FIG. 4 is a top view of the composite material;

FIG. 5 is a top view of the composite material with fold lines and double-sided adhesive;

FIG. 6 is a top view of the composite material folded into the unclosed envelope shape;

FIG. 7 is a perspective view of the composite unclosed envelope with release liner, where a pouch area is created by side gluing side crushing areas folding at a crush/fold area;

FIG. 8 is a perspective view of the composite closed envelope;

FIG. 9 is a perspective view showing a notched region for tear opening of a sealed envelope;

FIG. 10 is a side view of a single sided outer embossed layer of Kraft, a double layer of expanded paper and an inner layer of raised and recessed embossed paper;

FIGS. 11, 11A, 11B, 11C, and 11D are schematic representation of various patterns and sizes of hexagonal shaped embossments;

FIG. 12 is a side view of a single sided embossed layer, a layer of flat Kraft paper and a double layer of expanded paper between the embossed and flat layers;

FIG. 13 is a side view of an embossed sheet;

FIG. 14 is a side view of a two sided embossed paper as a cushioning inner layer;

FIG. 15 is a side view of the double sided embossed layer of FIG. 14 in combination with an inner and outer layer of single sided embossed Kraft paper;

FIG. 16 is a perspective view of the combination of FIG. 15;

FIG. 17 is a perspective view of a fan fold cushioning layer in combination with embossed layers;

FIG. 18 is a perspective view of an undulating two-sided pattern in combination with an embossed layer;

FIG. 19 is a plan view of two consecutive envelope pads that have been crushed in fold areas and die-cut in envelope end crush areas while, simultaneously being maintained under tension in the manufacturing direction in the sidecrushing areas;

FIG. 20 is a side view of the upper rotary tool that provides the crush and cut for making the padded envelope;

FIG. 21 is a side view of the die cut crush rotary system; and

FIG. 22 is a perspective view of the rotary padded envelope pad making section; and wherein:

b) FIGS. 23-34L illustrate preferred embodiments of the invention set forth in the present application, which are shown by way of example, and not limitation, wherein:

FIGS. 23-32 depict some preferred embodiments of the present invention in which cushioned envelopes are formed with a composite of a first outer sheet and a second inner sheet;

FIGS. 23, 24 and 25 are schematic and explanatory figures that only depict portions of the components (such as, for example, sub-portions of the inner sheet of paper 505A corresponding to particular envelopes 400A to be fabricated but prior to cutting or separating the inner sheet of paper 505A to form individual envelopes 400A).

FIG. 26 is a perspective view of an illustrative cushioned envelope according to some embodiments of the present invention;

FIG. 27 is a perspective view of a system for manufacturing cushioned envelopes in accordance with some embodiments of the present invention;

FIG. 28 is a schematic side view of additional components in the system for manufacturing cushioned envelopes shown in FIG. 27 according to some embodiments of the present invention;

FIG. 29 is an explanatory plan view depicting steps in relation to conveyance of first outer sheet 506A and second inner sheets 505A in a machine direction MD, and separation of a composite region for formation of individual envelopes in accordance with some preferred embodiments;

FIG. 30 is a plan view depicting a composite section for forming a single envelope 400A in accordance with some illustrative embodiments of the present invention;

FIG. 31 is a plan view depicting a single envelope 400A formed by folding over the composite section shown in FIG. 30 around the vertical line shown in the center of the region B in FIG. 30 to form the envelope 400A;

FIG. 32 is a perspective view of an illustrative envelope 400A similar to that shown in FIG. 31 in an open state with a flap 401A open, and with the pouch opening in an open position;

FIGS. 33A-33G are explanatory side views that show some additional illustrative embodiments of the invention employing alternative shapes and configurations of the second inner paper layer;

FIGS. 34A-34L are explanatory views showing various other surface configurations of the second inner paper layer in other embodiments of the invention, wherein the second inner paper layer includes other configurations for width-wise positional variations of the side surface of the second inner sheet that cushion items placed within an inner pouch of the envelope; and

FIG. 35 is a perspective view of a portion of a wall of a pouch of an envelope that is similar to the envelope shown in FIG. 26, which portion of the wall of the pouch of the envelope includes a first outer sheet 506A adhered a portion of a pleated second inner sheet 505A containing and cushioning an item within the pouch of the envelope.

### DESCRIPTION OF THE PREFERRED EMBODIMENTS OF THE INVENTION

While the present invention may be embodied in many different forms, the illustrative embodiments are described herein with the understanding that the present disclosure is to be considered as providing examples of the principles of the invention and that such examples are not intended to limit the invention to preferred embodiments described herein and/or illustrated herein.

According to some of the preferred embodiments, a novel cushioned envelope can be created with a composite of two sheets of paper. Among other things, creating novel cushioned envelopes from a composite of two sheets of paper can substantially reduced costs for manufacture.

According to some preferred embodiments, a novel envelope is created that improves upon the envelopes shown in, e.g., FIGS. 16-17 of the above-referenced parent application Ser. No. 16/870,195 by creating a cushioned envelope from a composite of two sheets. For example, in some of the preferred embodiments, the inner layer 104 can be eliminated. Among other things, eliminating the inner layer 104 can substantially reduce manufacturing costs.

According to some preferred embodiments, a novel envelope is created that includes a composite of: a) a first outer sheet of paper; and b) a second inner sheet of paper configured to provide cushioning, wherein the second inner sheet of paper forms an interior wall of the inner pouch of the envelope without an inner layer 104 (as shown in FIG. 16-17). Accordingly, in such preferred embodiments, the second inner sheet of paper configured to provide cushioning directly contacts items placed within the inner pouch of the envelope.

According to some preferred embodiments, the first outer sheet of paper can include a sheet of paper having no embossments or the like, such as to be substantially flat. In some embodiments, the first outer sheet of paper can comprise a sheet of Kraft paper. In some embodiments, the first outer sheet of paper can be a Kraft sheet having a weight of 30# (i.e., 30 lbs) paper or more under the TAPPI standard paper weight specification for 3000 square feet. In some embodiments, the first outer sheet of paper can be a Kraft sheet having a weight of 40# paper or more under the TAPPI standard paper weight specification for 3000 square feet. In some embodiments, the first outer sheet of paper can be a Kraft sheet having a weight of 50# paper or more under the TAPPI standard paper weight specification for 3000 square feet. In some embodiments, the first outer sheet of paper can be a Kraft sheet having a weight of 60# paper or more under the TAPPI standard paper weight specification for 3000 square feet.

In some preferred embodiments, the first outer sheet of paper is sufficiently strong to inhibit inadvertent tearing of the envelope during use, such as, e.g., during shipping and/or mailing.

Although the first outer sheet of paper is an unembossed sheet in some preferred embodiments, it some other preferred embodiments, the first outer sheet of paper can include embossments. For example, in some embodiments, the first outer sheet of paper can include any of the embossments as described in the foregoing sections incorporated herein from parent application Ser. No. 16/870,105.

According to some preferred embodiments, the second inner sheet of paper is configured to provide cushioning by providing width-wise positional variations of the side surface of the second inner sheet. In some preferred embodiments, the width-wise positional variations of the side surface of the second inner sheet include pleats. For example, in some embodiments, the second inner sheet of paper can include a pleated paper similar to 1400 shown in FIG. 17. In some other embodiments, the width-wise positional variations of the side surface of the second inner sheet include undulations. For example, in some embodiments, the second inner sheet of paper can include a paper similar to that shown in FIG. 16 with undulations similar to that of sheet 1300. In some other embodiments, the width-wise positional variations of the side surface of the second inner sheet include embossments. For example, in some embodiments, the second inner sheet of paper can include an embossed paper similar to that described in the foregoing sections incorporated herein from parent application Ser. No. 16/870,195. In some illustrative examples, the second inner sheet of paper can include an embossed paper similar to that shown in FIG. 13, which shows an illustrative embossed paper sheet 1001 having a pattern of embossments 1002 (such as, e.g., an array of circular, polygonal and/or other shaped embossments), extending therefrom in a single direction. In some other illustrative examples, the second inner sheet of paper can include an embossed paper similar to that shown in FIG. 14, which shows an illustrative two-sided pattern layer 1100 (i.e., with embossments extending in both directions) which increases the final thickness of the embossed sheet.

In the preferred embodiments, the width-wise positional variations of the side surface of the second inner sheet are configured to facilitate use and operation of the envelope, such as, e.g., to facilitate placement of items within a pouch of the envelope. For example, in preferred embodiments, the second inner sheet is configured to include positional variations of the side surface with minimal or no interference during placement of items within a pouch of the envelope. For example, in some preferred embodiments, the second inner sheet includes pleats having peaks that extend towards a opening into the pouch, such that items placed into the opening of the pouch are inserted in a direction parallel to or substantially parallel to peaks of said pleats. As another example, in some preferred embodiments, the second inner sheet includes embossments similar to that shown in FIG. 13, in which the embossments are arranged to extend outward of the interior of the pouch, such as to avoid contact with items during placement within the pouch.

According to some preferred embodiments, the second inner sheet of paper can be formed from a sheet of Kraft paper. In some embodiments, the second inner sheet of paper can be a Kraft sheet having a weight of 30# (i.e., 30 lbs) paper or more under the TAPPI standard paper weight specification for 3000 square feet. In some embodiments, the second inner sheet of paper can be a Kraft sheet having a weight of 40# paper or more under the TAPPI standard paper weight specification for 3000 square feet. In some embodiments, the second inner sheet of paper can be a Kraft sheet having a weight of 50# paper or more under the TAPPI standard paper weight specification for 3000 square feet. In some embodiments, the second inner sheet of paper can be a Kraft sheet having a weight of 60# paper or more under the TAPPI standard paper weight specification for 3000 square feet.

Referring to FIGS. 23-32, these figures show some preferred embodiments of the present invention in which cushioned envelopes are formed with a composite of a first outer sheet and a second inner sheet. In the embodiment shown in FIGS. 23-32, the second inner sheet includes pleats. Additionally, in the embodiment shown in FIGS. 23-32, a novel and advantageous manufacturing process is depicted.

According to the preferred embodiments shown in FIGS. 23-32, a novel envelope is created having substantial advantages over prior envelopes. Additionally, according to the preferred embodiments shown in FIGS. 23-32, the novel envelope is advantageously manufactured employing a highly cost-effective, quick and efficient system and method. In particular, in some preferred embodiments, a manufacturing system 500A (see FIG. 28) is employed to manufacture cushioned envelopes 400A (see FIGS. 26, 31 and 32). As shown in FIG. 27, in the illustrated embodiment, envelopes 400A are manufactured by conveying at least one first outer sheet of paper 506A (one shown in the illustrated embodiment) that is wound into at least one first roll of paper 501A (one shown in the illustrated embodiment) in a machine direction MD alongside at least one second inner sheet of paper 505A (two shown in the illustrated embodiment) that is wound into at least one second roll of paper 502A, 503A (two shown in the illustrated embodiment).

As shown in FIG. 27, during manufacture of the cushioned envelopes, each of the at least one second inner sheet of paper 505A is conveyed through a roller pair 504A having outer peripheries with at least one lengthwise rib configured to impart pleats in the at least one inner sheet of paper 505A. As schematically shown in FIGS. 23, 24 and 25, the illustrated embodiments regions 100A of the sheet(s) of paper 505A are employed for making respective envelopes 400A, wherein the regions 100A are conveyed in the machine direction MD (see FIGS. 23, 24, 25, 27, 29 and 30), with the pleats extending substantially perpendicular or transverse to the machine direction MD.

FIGS. 23, 24 and 25 are schematic and explanatory figures rather than actual drawings of the system shown in FIG. 27 because the figures only depict portions of the components (such as, for example, sub-portions of the inner sheet of paper 505A corresponding to particular envelopes 400A to be fabricated but prior to cutting or separating the inner sheet of paper 505A to form individual envelopes 400A). It should be appreciated, however, that FIGS. 23, 24 and 25 are schematic and explanatory figures to facilitate appreciation of embodiments of the present invention.

With reference to FIG. 23, according to the preferred embodiments, envelopes 400A are formed by conveying second inner sheets 505A in a machine direction with pleats extending substantially perpendicular or transverse to the machine direction. In this manner, envelopes 400A can be manufactured, in which regions 100A of the paper 505A are cut (after being combined with the paper 506A) to form individual envelopes 400A. In particular, in the preferred embodiments, individual envelopes 400A are advantageously formed with regions 100A of the paper 505A arranged such that individual envelopes are formed by conveying the regions 100A in the machine direction, with such regions 100A including a first sub-region (e.g., first half) 102A and a second sub-region 103A (e.g., second half) that can be folded over for forming of an inner wall of a pouch of the envelope. As schematically shown in FIG. 23, in forming of an envelope 400A, a region 100A can be cut from the paper 505A (in composite with a corresponding region of the paper 506A), folded over the region 101A, with sides 51 within sub-regions 102A and 103A adhered together at a first side of a pouch and sides S2 within sub-regions 102A and 103A adhered together at a second side of the pouch, and with an opening into the pouch formed between adjacent end regions E1 and E2 of the folded-over region 100A.

As schematically illustrated in FIG. 24, in some preferred embodiments, plural regions 100A can be conveyed side-by-side in the machine direction such as to form a plurality of envelopes 400A concurrently. In the illustrated example, two envelopes 400A are, thus, concurrently formed side-by-side. In some preferred embodiments, the respective regions 100A, 100A (e.g., shown in FIG. 24) are formed by conveying separate sheets conveyed from separate rolls (e.g., rolls 502A and 503A shown in FIG. 27). In some alternative embodiments, separate regions 100A, 100A can be formed by cutting or separating a sheet conveyed from a single roll (e.g., providing a wider roll 502A′ (not shown) having a width comparable to that of rolls 502A and 503A combined, and cutting the conveyed sheet rather than employing two separate rolls 502A and 503A.

As shown in FIGS. 23, 24, 25 and 27, in some preferred embodiments, the adjacent regions 100A are separated from one another by a gap 201A (see FIG. 24). In some alternative embodiments, adjacent regions 100A can directly abut or contact one another. Additionally, in some alternative embodiments, adjacent regions 100A can be formed from a single sheet of paper (e.g., 505A′ not shown), which can be cut into separated sheets (e.g., similar to 505A shown in FIG. 27) either prior to or after being formed into a composite structure with the first outer sheet (e.g., 506A shown in FIG. 27).

With reference to FIG. 25, the figure schematically depicts plural regions 100A alongside a portion 506A″ of the first outer sheet 506A. As noted above, FIG. 25 is a schematic and explanatory figure and only depicts portions of the components (such as, for example, sub-portions 100A of the inner sheet of paper 505A corresponding to particular envelopes 400A to be fabricated but prior to cutting or separating the inner sheet of paper 505A to form individual envelopes 400A, as well as the portion 506A″ of the first outer sheet for explanatory purposes).

With reference to FIG. 27, in the illustrative example shown, in the manufacture of the envelopes 400A, the first outer layer of paper 506A is unwound from the roll(s) 501A and directed in a machine direction MD via conveying rollers R. Additionally, the second outer layer(s) of paper 505A is unwound from the roll(s) 502A, 503A and directed in the machine direction MD towards the roller pair 504A having outer peripheries with at least one lengthwise rib configured to impart pleats in the at least one inner sheet of paper 505A. Although such a roller pair 504A is provided in some embodiments, in other embodiments any other structure for imparting pleats to the paper 505A can be employed, such as, e.g., any of the structures for imparting pleats as described in the patents and/or publications incorporated by reference in the present application, such as, by way of example, patents and publications discussed above in relation to, e.g., FIGS. 16-18 of the parent application. Additionally, the pleats created in embodiments of the present invention can be formed like any of the pleats described in any of the patents and publications discussed and incorporated herein-by-reference above and/or like any of the pleated embodiments describe herein-above in relation to the parent application subject matter included herein.

With further reference to FIG. 28, after the second inner sheet(s) 505A are pleated and the first outer sheet 506A and the second inner sheet(s) 505A are brought close together (e.g., proximate roller R4), a composite structure of the first outer sheet 506A and the second inner sheet(s) 505A is formed by adhering the first outer sheet and the second inner sheet(s) together. Towards that end, in some preferred embodiments, an adhesive is applied in between the first outer sheet and the second inner sheet(s), such as, for example, employing a glue dispensing mechanism CG shown schematically in FIG. 28. In some embodiments, the glue dispensing mechanism is adapted to move (e.g., via computer automation) to apply glue at a plurality of locations. In some embodiments, the glue dispensing mechanism includes a plurality of outlets arranged to apply glue in specific regions (such as, for example, within regions A, B, C, D, E shown in FIGS. 28, 31 and 32).

In some preferred embodiments, as the first sheet 506A and the second sheet(s) 505A are conveyed adjacent one another as shown in FIG. 28, a plurality of pairs of pressing rollers 100R2 are aligned such as to press the first sheet 506A and the second sheet(s) 505A together, after the application of adhesive from the glue dispensing mechanism, which pressing rollers 100R2 are arranged to press at regions corresponding to regions A and C shown in FIG. 30. In some embodiments, the region B shown in FIG. can also be pressed and glued together to facilitate folding for formation of the envelope 400A. In the preferred embodiments, the pressing rollers 100R2 are arranged to apply pressure between the first sheet 506A and the second sheet(s) 505A such as to adhere the first and second sheets together across the entire width of the respective composite structure that forms a respective envelope 400A. Additionally, in some preferred embodiments, the regions A, B and/or C can be pressed such as to collapse the pleats within such regions in order to provide a strong adhesion between the first sheet 506A and the second sheet(s) 505A.

As further shown in FIG. 28, in some embodiments, as the first sheet 506A and the second sheet(s) 505A are further conveyed adjacent one another as shown in FIG. 28, individual envelopes are separated and cut from the elongated connected first sheet 506A and second sheet(s) 505A, such as, for example, employing a roller 100R1, which preferably is configured similarly to the rollers 100 shown in FIG. 20 of the parent application, and similarly includes a pressing portion 102R1 and a cutting portion 103R1. In some preferred embodiments, the pressing portion 102R1 is configured to press regions D and E shown in FIGS. 31 and 32, and the cutting portion 103R1 is configured to separate adjacent composite structures similar to that shown in the top of FIG. 29. For example, in some examples, the cutting portion 103R1 can be employed to cut the composite of the first sheet 506A and the second sheet(s) 505A at the position C1 shown in FIG. 29.

As shown in FIG. 29, although not shown in FIG. 27 or 28, in embodiments like that shown in FIG. 29, in order to separate adjacent composite members for forming plural envelopes, the first sheet 506A can also be cut along the machine direction along line shown at the position C2 in FIG. 29.

After separation of a composite section for forming a single envelope 400A similar to that shown in FIG. 30, the composite section shown in FIG. 30 can be folded over around the vertical line shown in the center of the region B in FIG. 30 to form the envelope 400A as shown in FIG. 31. As shown in FIG. 31, to form the envelope 400A, the lateral sides of the envelope 400A are preferably adhered together within the regions D and E. Additionally, the region 401A, formed by a section of the first sheet 506A that extends beyond the edge of the respective portion of the second sheet 505A operates as a flap of the envelope. In some embodiments, as shown in FIG. 31, an adhesive strip 402A can be provided to facilitate closing of the envelope. In some embodiments, the adhesive strip 402A includes a removable release liner for covering of the adhesive strip until it is desired to fold the flap over and seal the envelope.

Although in some preferred embodiments, the regions D and E have been pressed and adhered together employing the roller 100R1 shown in FIG. 28 (as discussed above), in some alternative embodiments, the roller 100R1 can simply cut the adjacent sections for forming individual envelopes 400A without pressing and adhering the first sheet and the second sheet. Then, after folding over of the envelope 400A as shown in FIG. 31, the lateral side regions D and E can be glued and pressed together, such as, e.g., employing pressing rollers and a glue dispensing mechanism similar to the pressing rollers and glue dispensing mechanism described above.

FIG. 32 shows a perspective view of an illustrative envelope 400A similar to that shown in FIG. 31 in an open state with the flap 401A open, and the pouch opening in an open position to receive an item therein in the direction of the arrow shown in FIG. 32. As described above, although not shown in FIG. 32, in the preferred embodiments, the pleats are arranged such that the ridges extend parallel to the lateral sides of the pouch, such that an item placed within the pouch opening is directed substantially parallel to the direction of the ridges.

In the embodiments shown in FIGS. 29-32, the composite of the portion 100A of the second sheet 505A and the corresponding portion 200A of the first sheet 506A employed for forming a single envelope 400A are sized such as to align with one another along upper left and bottom sides shown in FIG. 30, with the portion 200A of the first sheet extending further outward such as to form a flap 401A of the envelope. Moreover, as shown in FIG. 29, the strips 505A are shown as separated by a distance corresponding to the flap portion 401A. However, in other embodiments, the composite of the first sheet and the second sheet can include first sheets and second sheets having the same dimensions, whereby a flap portion that is created would have both sheets. In such an embodiment, the entire flap portion is preferably pressed and glued similarly to the region C shown in, e.g., FIG. 32.

With respect to the illustrative example of the envelope 400A shown in FIG. 26, the envelope shown in FIG. 26 includes some illustrative modifications from that shown in, e.g., FIG. 32. For example, in the embodiment shown in FIG. 26, the flap 401A is cut narrower. Additionally, in the embodiment shown in FIG. 26, the envelope is not pressed flat such as to flatten the pleats or undulations in the region B corresponding to the position at which the envelope is folded during manufacture. Additionally, in the embodiment shown in FIG. 26, the envelope is not pressed flat such as to flatten the pleats or undulations in the regions A and C corresponding to the position at which the envelope is folded during manufacture. Thus, as shown proximate the opening of the pouch in FIG. 26, in some embodiments, the pleatings or undulations can, thus, extend to the opening of the pouch (as shown). It should be appreciated that the second inner layer would, however, be adhered to the first outer layer, such that upon manual opening of the opening of the pouch, the second inner layer would adhere to the first outer layer on both sides of the opening of the pouch such as to enable a user to access the interior of the pouch.

In various embodiments, adhesives employed to form the envelopes 400A can include hot adhesives, cold adhesives and/or any other adhesives or sealants. In some preferred embodiments, the adhesives employed to form the envelopes (such as, e.g., employed within glue dispensing mechanism CG shown in FIG. 28) are or include cold glues. In some preferred embodiments, cold glues are water-based solutions. In some examples, the cold glues include adhesive are dissolved in water. In some embodiments, cold glues include one or more of the following types: 1) starch; 2) dextrine-depolymerized starches; and/or 3) polyvinyl alcohol solutions (PVOH).

In some preferred embodiments, pleats of the second inner sheet are adhered to a side surface of the first outer sheet using an adhesive. For example, in some preferred embodiments, an adhesive can be applied in a region of contact between the apices of the pleats of the second inner sheet and the side surface of the first outer sheet. In some embodiments, the adhesive can extend along a substantial portion of or the entire length of the region of contact between the apices of the pleats of the second inner sheet and the side surface of the first outer sheet. In some other embodiments, the adhesive can be located at discrete locations or at intervals along the length of the region of contact between the apices of the pleats of the second inner sheet and the side surface of the first outer sheet. For example, FIG. 35 is a perspective view of a portion of a wall of a pouch of an envelope that is like the envelope shown in FIG. 26, which portion of the wall of the pouch of the envelope includes a first outer sheet 506A adhered a portion of a pleated second inner sheet 505A containing and cushioning an item within the pouch of the envelope. As shown in the embodiment of FIG. 35, pleats P of a second inner sheet 505A are adhered to a side surface of a first outer sheet 506A using an adhesive (such as, e.g., using a glue dispensing mechanism CG like that shown in FIG. 28 with any of the adhesives described herein). For example, in some preferred embodiments, an adhesive can be applied in a region of contact between the apices (i.e., apexes) AP of the pleats P of the second inner sheet and the side surface of the first outer sheet. For example, in some embodiments, an adhesive can be applied along a substantial portion of or the entire length of the region of contact between the apices AP of the pleats of the second inner sheet and the side surface of the first outer sheet. For example, in some embodiments, a glue line GL (shown in dashed lines in FIG. 35 since the glue line would be located upon the apices AP situated below the sheet 506A in the view shown in FIG. 35) can extend along a substantial portion of or the entire length of the apices. In some other embodiments, the adhesive can be located at discrete locations or at intervals along the length of the region of contact between the apices of the pleats of the second inner sheet and the side surface of the first outer sheet. For example, in some embodiments glue spots GS (similarly, shown in dashed lines in FIG. 35 since the glue spots would be located upon the apices AP situated below the sheet 506A in the view shown in FIG. 35) can be applied at discrete locations or at intervals along the length of the region of contact between the apices of the plates of the second inner sheet and the side surface of the first outer sheet.

In some preferred embodiments, as shown in FIG. 35, each of the pleats P forms substantially isosceles triangles in which the length of each side of the pleat (e.g., sides P1 and P2) is the same and the apices AP of the pleats at the juncture between such equal length sides P1 and P2 of adjacent pleats P contact and are adhered to the side surface of the first outer sheet. In some preferred embodiments, each of the pleats P forms a substantially equilateral triangle in which the length of each side P1 and P2 of the pleat is substantially the same or the same and the pleat width PW parallel to the plane of the first outer sheet between adjacent apices AP is also substantially the same or the same as the lengths of each of the sides P1 and P2.

Among other things, the preferred embodiments of the present invention can achieve a very strong protective envelope structure with minimal materials. For example, the most preferred embodiments can employ merely two sheets of paper that are adhered together at limited regions. Additionally, the most preferred embodiments can also provide cushioning using triangular-shaped cushioning cells made with such pleats. Notably, triangles are the strongest polygon shapes, especially isosceles and equilateral triangles, enabling substantial cushioning with limited materials.

With further reference to FIG. 35, the most preferred embodiments not only achieve a highly effective cushioning with triangular-shaped cushion cells formed by the adherence of the pleats of the second inner sheet to the surface of the first outer sheet, but also achieve a substantial reduction of friction forces applied to an item when the item is inserted into and/or removed from the pouch of an envelope. For example, the illustrative structure shown in FIG. 35 advantageously achieves substantial cushioning capabilities that helps protect an item (see ITEM depicted in FIG. 35) from external vertical forces in the direction of the arrows VF shown in FIG. 35, while simultaneously achieving substantial reduction in friction forces imparted to items that are inserted into and/or removed from the pouch upon movement of the item relative to the wall of the pouch in the direction of the arrows HF shown in FIG. 35.

In some embodiments, each of the pleats substantially forms a triangle having an angle at the apices between adjacent pleats contacting the surface of the first outer sheet of paper, which angle is between 40 to 80 degrees, or, in some preferred embodiments, between 45 to 75 degrees, or, in some preferred embodiments, between 50 to 70 degrees, or, in some preferred embodiments, between 55 to 65 degrees, or, in some preferred embodiments, about 60 degrees. In other less preferred embodiments, the angle can be greater than 80 degrees, such as, e.g., 90 degrees or more, or 100 degrees or more, or 110 degrees or more, or 120 degrees or more. Similarly, in other less preferred embodiments, the angle can be smaller than 40 degrees, such as, e.g., 35 degrees or less, or 30 degrees or less, or 25 degrees or less.

It should be appreciated that in the preferred embodiments, the walls P1 and P2 of the pleats would not be exactly linear and formed as exact flat planes, but would have some variation in shape such as some curvature, dimples or other irregularities, and that the apices AP between the respective pleats P and the bottom tips BT at the bottom ends of the pleats P would not be exact angles, but would have some variation in shape such as rounding or other irregularities. Accordingly, in this application, the terminology triangle or triangular, or isosceles triangle, or equilateral triangle should not be construed as referring to mathematically or geometrically exact geometrical shapes.

With respect to FIGS. 33A-33G, these figures show some additional illustrative embodiments of the invention employing alternative shapes and configurations of the second inner paper layer, which provides cushioning within a pouch of the envelope. In particular, in the embodiments shown in FIGS. 33A-33G, the second inner paper sheet is formed to have a consistent cross-sectional shape across the entire sheet. Specifically, FIGS. 33A-33G show an edge-view of a sheet, similar to sheet 505A shown in, e.g., FIG. 29, from a direction perpendicular to the machine direction MD shown in FIG. 29. In each of the embodiments shown in FIGS. 33A-33G, the shapes includes pleatings or undulations that create ridges that extend substantially transverse to the machine direction. In some preferred embodiments, the ridges extend a distance of greater than 30% of the depth of the envelope from the opening to a bottom of the pouch of the envelope, or, in some preferred embodiments, wherein the ridges extend a distance of greater than 40% of the depth of the envelope from the opening to a bottom of the pouch of the envelope, or, in some preferred embodiments, the ridges extend a distance of greater than 50% of the depth of the envelope from the opening to a bottom of the pouch of the envelope, or, in some preferred embodiments, the ridges extend a distance of greater than 60% of the depth of the envelope from the opening to a bottom of the pouch of the envelope, or, in some preferred embodiments, the ridges extend a distance of greater than 70% of the depth of the envelope from the opening to a bottom of the pouch of the envelope, or, in some preferred embodiments, the ridges extend a distance of greater than 80% of the depth of the envelope from the opening to a bottom of the pouch of the envelope, or, in some preferred embodiments, the ridges extend a distance of greater than 90% of the depth of the envelope from the opening to a bottom of the pouch of the envelope, or, in some preferred embodiments, the ridges extend a distance of greater than 95% of the depth of the envelope from the opening to a bottom of the pouch of the envelope.

With respect to FIGS. 33A-33C, these figures show illustrative embodiments with smoothly curved variations in width-wise position of the sidewall of the second inner paper layer, with FIG. 33A showing a tighter or more compact sinusoidal structure and FIG. 33B showing a wider or less compact structure. It should be appreciated that the arc of curvature can vary in different embodiments, such as, e.g., between the arcs shown in these figures, or even greater than that shown in FIG. 33B or even less than that shown in FIG. 33A. Similarly, the various angles and dimensions of the embodiments shown in FIGS. 33D-33G can also be varied, as desired, in various embodiments of the present invention. Additionally, the distance between pleatings and/or undulations or the like can be modified, such as to, e.g., have similar sizes pleatings and/or undulations or the like separated at greater distances or closer together in some alternative embodiments. In some illustrative examples, the triangular shaped pleatings shown in FIG. 33E can be modified to adapt the angles at the peaks of the triangles to that desired. In some illustrative and non-limiting embodiments, such angles can be between about 20° to 135°, while in some illustrative and non-limiting embodiments, such angles can be between about 45° and 90°. In other embodiments, the angle can be similar to any of the embodiments described in any of the patents or publications incorporated herein by reference or in any of the embodiments of the parent application described and included herein above.

In some illustrative embodiments, the second inner paper layer can include width-wise positional variations of the side surface of the second inner sheet that cushion items placed within an inner pouch of the envelope, wherein the width-wise positional variations of the side surface result in an increased width h (see, e.g., width h shown for illustrative purposes in FIGS. 33A, 33C, 33E and 33G). In some illustrative embodiments, the increased width h of the second inner paper layer is at least 1/16 inch. In some illustrative embodiments, the increased width h of the second inner paper layer is at least ⅛ inch. In some illustrative embodiments, the increased width h of the second inner paper layer is at least ¼ inch. In some illustrative embodiments, the increased width h of the second inner paper layer is at least ½ inch. In some illustrative embodiments, the increased width h of the second inner paper layer is between about 1/16 inch and ½ inch. In some illustrative embodiments, the increased width h of the second inner paper layer is between about ⅛ inch and ¼ inch.

With reference to FIGS. 34A-34L, some further embodiments of the invention are depicted which employ other configurations for the second inner paper layer, wherein the second inner paper layer includes other configurations for width-wise positional variations of the side surface of the second inner sheet that cushion items placed within an inner pouch of the envelope. In some preferred implementations of the embodiments shown in FIGS. 34A-34L, the width-wise positional variations of the side surface result in an increased width h having a depth like that of the various embodiments described above.

With reference to the embodiment shown in FIG. 34A, the second inner sheet can include a plurality of undulations caused by forming the sheet to have curved (e.g., sinusoidal) configurations as viewed along both the x and y axes as shown, such as to create an array of curved protrusions extending upwardly in the axis z such as to have a width h.

With reference to the embodiment shown in FIG. 34B, the second inner sheet can include a plurality of pleats of different widths h, as shown, and/or with increased spacing between pleats as shown in some illustrative embodiments.

With reference to the embodiment shown in FIG. 34C, the second inner sheet can include an array or distribution of embossments, such as, e.g., the irregular (e.g., rounded) embossments as shown in the figure. In some embodiments, the edges of the embossments are arcuate and/or rounded to facilitate insertion of items into a pouch of the envelope.

With reference to the embodiment shown in FIG. 34D, the second inner sheet can include a plurality of elongated undulations or embossments in some illustrative embodiments. In the preferred embodiments, the elongated undulations or embossments extend such that ridges thereof extend substantially perpendicularly to the opening of the pouch, similar to the ridges of the pleats shown in FIG. 30.

With reference to the embodiment shown in FIG. 34E, the second inner sheet can include an irregular configuration as shown, such as to impart width-wise variation having a width h similar to that of other embodiments discussed herein. Upon adhering the second inner sheet to the first outer sheet (e.g., upon adhering by cold glue or the like the first outer sheet to adjacent portions of the second inner sheet), the variations of the second inner sheet can impart cushioning.

With reference to the embodiments shown in each of FIGS. 34F-34L, in various embodiments in which pleatings or undulations are formed, the pleatings or undulations do not necessarily have to have a consistent cross-sectional shape like that of the embodiments shown in, e.g., FIGS. 33A-33G, as well as in FIG. 8A. Specifically, FIGS. 34F-34L show illustrative embodiments that employ a variety of other pleating or undulation formations that can be provided in other embodiments of the invention for the second inner paper layer 505A. However, it should be appreciated that formation of pleatings or undulations similar to that shown in, e.g., FIGS. 33A-33G can be performed with less complex equipment (e.g., rollers, etc.).

According to the preferred embodiments, a highly advantageous and novel envelope is created having substantial benefits over prior envelopes, including substantial cost savings. Additionally, in the preferred embodiments, envelopes 400A are created that are recyclable, being made with paper, as described herein-above, with minimal glue in preferred embodiments of the invention.

### Broad Scope of the Invention

The use of individual numerical values is stated as approximations as though the values were preceded by the word “about”, “substantially”, or “approximately.” Similarly, the numerical values in the various ranges specified in this application, unless expressly indicated otherwise, are stated as approximations as though the minimum and maximum values within the stated ranges were both preceded by the word “about”, “substantially”, or “approximately.” In this manner, variations above and below the stated ranges can be used to achieve substantially the same results as values within the ranges. As used herein, the terms “about”, “substantially”, and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about”, “substantially”, or “approximately” will serve to broaden a particular numerical value or range. Thus, as a general matter, “about”, “substantially”, or “approximately” broaden the numerical value. Also, the disclosure of ranges is intended as a continuous range including every value between the minimum and maximum values plus the broadening of the range afforded by the use of the term “about”, “substantially”, or “approximately”. Thus, recitation of ranges of values herein are merely intended to serve as a shorthand method of referring individually to each separate value falling within the range, unless otherwise indicated herein, and each separate value is incorporated into the specification as if it were individually recited herein.

To the extent that determining a given amount of variation of some the factors such as the criticality of the slit patterns, paper width differential pre- and post-expansion, paper weights and type, as well as other considerations known to those of skill in the art to which the disclosed subject matter is most closely related or the art relevant to the range or element at issue will have on the performance of the claimed subject matter, is not considered to be within the ability of one of ordinary skill in the art, or is not explicitly stated in the claims, then the terms “about”, “substantially”, and “approximately” should be understood to mean the numerical value, plus or minus 15%.

It is to be understood that any ranges, ratios and ranges of ratios that can be formed by, or derived from, any of the data disclosed herein represent further embodiments of the present disclosure and are included as part of the disclosure as though they were explicitly set forth. This includes ranges that can be formed that do or do not include a finite upper and/or lower boundary. Accordingly, a person of ordinary skill in the art most closely related to a particular range, ratio or range of ratios will appreciate that such values are unambiguously derivable from the data presented herein.

What is claimed is:

1. A protective product, comprising:
an envelope having a two-layer wall structure,
the two-layer wall structure including:
a) a first outer paper layer, and
b) a second inner paper layer,
wherein the second inner paper layer:
i) includes width-wise positional variations of the side surface of the second inner paper layer that cushions items placed within an inner pouch of the envelope, and
ii) forms an interior wall of the inner pouch of the envelope and directly contacts the items placed within the inner pouch of the envelope,

2. The protective product of claim 1, wherein said first outer paper layer and said second inner paper layer are folded together to form a pouch, with said second inner paper layer forming the interior wall of said pouch that directly contacts items placed within said pouch during use and with said first outer paper layer forming an outside wall of said pouch at an exterior of the envelope.

3. The protective product of claim 1 or any of the preceding claims, wherein said width-wise positional variations of the side surface of the second inner paper layer includes pleats, undulations and/or embossments.

4. The protective product of claim 3, wherein said pleats, undulations and/or embossments include ridges that extend perpendicular or substantially perpendicular to an outlet of the envelope.

5. The protective product of claim 4, wherein said ridges extend a distance of greater than 30% of the depth of the envelope from the opening to a bottom of the pouch of the envelope, or, in some preferred embodiments, wherein said ridges extend a distance of greater than 40% of the depth of the envelope from the opening to a bottom of the pouch of the envelope, or, in some preferred embodiments, wherein said ridges extend a distance of greater than 50% of the depth of the envelope from the opening to a bottom of the pouch of the envelope, or, in some preferred embodiments, wherein said ridges extend a distance of greater than 60% of the depth of the envelope from the opening to a bottom of the pouch of the envelope, or, in some preferred embodiments, wherein said ridges extend a distance of greater than 70% of the depth of the envelope from the opening to a bottom of the pouch of the envelope, or, in some preferred embodiments, wherein said ridges extend a distance of greater than 80% of the depth of the envelope from the opening to a bottom of the pouch of the envelope, or, in some preferred embodiments, wherein said ridges extend a distance of greater than 90% of the depth of the envelope from the opening to a bottom of the pouch of the envelope, or, in some preferred embodiments, wherein said ridges extend a distance of greater than 95% of the depth of the envelope from the opening to a bottom of the pouch of the envelope

6. The protective product of claim 1 or any of the preceding claims, wherein said width-wise positional variations of the side surface of the second inner paper layer includes peaks adjacent said first outer paper layer, and wherein adhesive is applied between said peaks and said first outer paper layer that adheres said second inner paper layer to said first outer paper layer.

7. The protective product of claim 1 or any of the preceding claims, wherein said width-wise positional variations of the side surface of the second inner paper layer includes peaks adjacent said first outer paper layer, wherein said peaks extend substantially perpendicular to an opening into a pouch of said envelope.

8. The protective product of claim 1 or any of the preceding claims, wherein said first outer paper sheet is an unembossed paper sheet.

9. The protective product of claim 1 or any of the preceding claims, wherein said first outer paper sheet is an embossed paper sheet.

10. The protective product of claim 1 or any of the preceding claims, wherein said first outer paper sheet is a substantially flat paper sheet.

11. The protective product of claim 1 or any of the preceding claims, wherein said first outer paper sheet is a Kraft paper sheet.

12. The protective product of claim 1 or any of the preceding claims, wherein said first outer paper sheet is a Kraft paper sheet having a weight of 30# or more under the TAPPI standard paper weight specification for 3000 square feet.

13. The protective product of claim 1 or any of the preceding claims, wherein said first outer paper sheet is a Kraft paper sheet having a weight of 40# or more under the TAPPI standard paper weight specification for 3000 square feet.

14. The protective product of claim 1 or any of the preceding claims, wherein said first outer paper sheet is a Kraft paper sheet having a weight of 50# or more under the TAPPI standard paper weight specification for 3000 square feet.

15. The protective product of claim 1 or any of the preceding claims, wherein said first outer paper sheet is a Kraft paper sheet having a weight of 60# or more under the TAPPI standard paper weight specification for 3000 square feet.

16. The protective product of claim 1 or any of the preceding claims, wherein said second inner paper sheet is a Kraft paper sheet having a weight of 30# or more under the TAPPI standard paper weight specification for 3000 square feet, or, in some examples, 40# or more under the TAPPI standard paper weight specification for 3000 square feet, or, in some examples, 50# or more under the TAPPI standard paper weight specification for 3000 square feet, or, in some examples, 60# or more under the TAPPI standard paper weight specification for 3000 square feet.

17. The protective product of claim 1 or any of the preceding claims, wherein the first outer paper sheet is adhered to the second inner paper sheet.

18. The protective product of claim 1 or any of the preceding claims, wherein the first outer paper sheet is adhered to the second inner paper sheet with cold glue.

19. A method, comprising:
providing the protective product of claim 1 or any of the preceding claims; and
placing an item within a pouch of said protective product.

20. A method of making the protective product comprising an envelope having a two-layer wall structure, the two-layer wall structure including a) a first outer paper layer, and b) a second inner paper layer, wherein the second inner paper layer includes width-wise positional variations of the side surface of the second inner paper layer that cushions items placed within an inner pouch of the envelope, and forms an interior wall of the inner pouch of the envelope and directly contacts the items placed within the inner pouch of the envelope, comprising the steps of:
a) conveying the first outer paper layer in a machine direction;
b) conveying the second inner paper layer in the machine direction alongside said first outer paper layer;
c) creating width-wise positional variations of the side surface of the second inner paper layer for cushioning items placed within an inner pouch of the envelope, said width-wise positional variations including ridges that extend transverse to the machine direction;
d) adhering the first outer paper layer to the second inner paper layer;
e) cutting a composite section of the first outer paper layer and the second inner paper layer for forming at least one individual envelope by severing the first outer paper layer and the second inner paper layer across a width thereof transverse to the machine direction; and
f) folding the composite section of the first outer paper layer and the second inner paper layer around a fold line parallel to the machine direction to create the inner pouch and such that the second inner paper layer forms the interior wall of the inner pouch of the envelope and directly contacts the items placed within the inner pouch, and wherein said ridges extend within said pouch substantially transverse to the opening of the pouch.

21. The method of claim 20, wherein said adhering includes cold gluing the first outer paper layer to the second inner paper layer.

22. An envelope, comprising: a composite of a) a first outer sheet of paper;
and b) a second inner sheet of paper configured to provide cushioning, wherein the second inner sheet of paper forms an interior wall of the inner pouch of the envelope without an inner layer, the second inner sheet of paper being configured to provide cushioning and directly contacting items placed within the inner pouch of the envelope.

23. The envelope of claim 22, wherein the first outer sheet of paper includes a sheet of paper having no embossments.

24. The envelope of claim 22 or 23, wherein the first outer sheet of paper comprises a sheet of Kraft paper, or, in some embodiments, wherein the first outer sheet of paper is a Kaft sheet having a weight of 30# paper or more under the TAPPI standard paper weight specification for 3000 square feet, or, in some embodiments, wherein the first outer sheet of paper is a Kaft sheet having a weight of 40# paper or more under the TAPPI standard paper weight specification for 3000 square feet, or, in some embodiments, wherein the first outer sheet of paper is a Kaft sheet having a weight of paper or more under the TAPPI standard paper weight specification for 3000 square feet, or, in some embodiments, wherein the first outer sheet of paper is a Kaft sheet having a weight of 60# paper or more under the TAPPI standard paper weight specification for 3000 square feet.

25. The envelope of any of claims 22-24, wherein the first outer sheet of paper is sufficiently strong to inhibit inadvertent tearing of the envelope during use, such as, e.g., during shipping and/or mailing.

26. The envelope of any of claims 22-24, wherein the first outer sheet of paper includes embossments.

27. The envelope of any of the preceding claims, wherein the second inner sheet of paper is configured to provide cushioning by providing width-wise positional variations of the side surface of the second inner sheet.

28. The envelope of any of the preceding claims, wherein the width-wise positional variations of the side surface of the second inner sheet include pleats.

29. The envelope of any of the preceding claims, wherein the width-wise positional variations of the side surface of the second inner sheet include undulations.

30. The envelope of any of the preceding claims, wherein the width-wise positional variations of the side surface of the second inner sheet include embossments.

31. The envelope of any of the preceding claims, wherein the width-wise positional variations of the side surface of the second inner sheet include embossments extending in a direction away from an interior of the pouch.

32. The envelope of any of the preceding claims, wherein the width-wise positional variations of the side surface of the second inner sheet include embossments extending only in a direction away from an interior of the pouch.

33. The envelope of any of the preceding claims, wherein the width-wise positional variations of the side surface of the second inner sheet include embossments extending both in a direction away from an interior of the pouch and extending in a direction toward the interior of the pouch.
